(19) United States
(12) Patent Application Publication
(10) Pub. No.: US 2020/0048556 A1
(43) Pub. Date: Feb. 13, 2020

(54) LIQUID CRYSTAL ALIGNING AGENT, LIQUID CRYSTAL ALIGNMENT FILM AND LIQUID CRYSTAL ELEMENT

(71) Applicant: JSR CORPORATION, TOKYO (JP)

(72) Inventors: Yoshitaka Murakami, TOKYO (JP); KEN-ICHI ITOU, TOKYO (JP); TAKASHI OKADA, TOKYO (JP)

(73) Assignee: JSR CORPORATION, TOKYO (JP)

(21) Appl. No.: 16/342,982

(22) PCT Filed: Oct. 19, 2017
(86) PCT No.: PCT/JP2017/037833

§ 371 Date: Apr. 18, 2019

(30) Foreign Application Priority Data
Oct. 20, 2016 (JP) 2016-206306
May 1, 2017 (JP) 2017-091427

(51) Int. Cl. C09K 19/56; C09D 179/08; C09D 7/20; G02F 1/1337

(52) U.S. Cl. CPC C09K 19/56; C09D 179/08; C09K 2019/525; G02F 1/133711; G02F 1/133723; C09D 7/20

(57) ABSTRACT

A liquid crystal aligning agent which contains a polymer (A) and a polymer (B). Polymer (A): A polymer which has at least one structural unit U1 selected from the group consisting of structural units represented by formula (1) and structural units represented by formula (2), and a structural unit U2 derived from at least one monomer selected from the group consisting of styrene monomers and (meth)acrylic monomers. Polymer (B): At least one polymer selected from the group consisting of polyamic acids, polyamic acid esters and polyimides. In the formulae, R⁷ represents a monovalent organic group having one or more carbon atoms; R⁸ represents a monovalent organic group having one or more carbon atoms; and R⁹ represents a hydrogen atom or a monovalent organic group having one or more carbon atoms.

### TECHNICAL FIELD

Priority is claimed on Japanese Patent Application No. 2016-206306, filed Oct. 20, 2016, and Japanese Patent Application No. 2017-091427, filed May 1, 2017, the content of which are incorporated herein by reference.

The present disclosure relates to a liquid crystal aligning agent, a liquid crystal alignment film, and a liquid crystal element.

### BACKGROUND ART

As liquid crystal elements, various liquid crystal elements such as a liquid crystal element in a horizontal alignment mode using a nematic liquid crystal having positive dielectric anisotropy represented as a twisted nematic (TN) type or a super twisted nematic (STN) type and a vertical alignment (VA) type liquid crystal element in a vertical (homeotropic) alignment mode using a nematic liquid crystal having negative dielectric anisotropy are known. Such liquid crystal elements include a liquid crystal alignment film having a function of aligning liquid crystal molecules in a certain direction.

Generally, a liquid crystal alignment film is formed by applying a liquid crystal aligning agent in which a polymer component is dissolved in an organic solvent to a substrate and heating it. As the polymer component of the liquid crystal aligning agent, a polyamic acid and a soluble polyimide are generally used because they have excellent mechanical strength, liquid crystal alignment properties, and affinity with a liquid crystal.

As a method of imparting a liquid crystal alignment ability to a polymer thin film formed using a liquid crystal aligning agent, a photoalignment method has been proposed as an alternative technology to a rubbing method. The photoalignment method is a method in which polarized or non-polarized radiation light is emitted to a radiation-sensitive organic thin film formed on a substrate to impart anisotropy to the film, and thus alignment of liquid crystals is controlled. According to this method, compared to a rubbing method of the related art, it is possible to reduce an amount of dust generated and static electricity in a process, and it is possible to reduce the occurrence of display defects and a decrease in the yield. In addition, there is an advantage in that it is possible to uniformly impart a liquid crystal alignment ability to an organic thin film formed on a substrate.

As a liquid crystal aligning agent for forming a liquid crystal alignment film according to a photoalignment method, various polymer compositions have been proposed in the related art. As one of them, for example, there is a liquid crystal aligning agent for photoalignment using a polymer having a main skeleton different from that of a polyamic acid and a soluble polyimide (for example, refer to Patent Literature 1 and Patent Literature 2). Patent Literature 1 discloses a photoalignable composition including a first polymer having poly(maleimide), and poly(maleimide-styrene) as a main chain and a side chain into which a photosensitive group is introduced, and a second polymer having a long chain alkyl group on a side chain. In addition, Patent Literature 2 discloses a liquid crystal aligning agent including a copolymer having a structural unit with a styrene skeleton as a main chain and a cinnamic acid structure in a side chain, and a structural unit with a maleimide skeleton as a main chain and a cinnamic acid structure in a side chain.

### REFERENCE LIST

### Patent Literature

### [Patent Literature 1]

Japanese Patent No. 2962473

### [Patent Literature 2]

Japanese Patent No. 3612308

### SUMMARY OF INVENTION

### Technical Problem

When heating at a high temperature is necessary in the formation of a liquid crystal alignment film, a material of a substrate is limited, and, for example, application of a film substrate as a substrate of a liquid crystal element may be limited. In addition, in a color liquid crystal display element, a dye used in a coloring agent for a color filter is relatively weak with respect to heat, and when it is necessary to perform heating at a high temperature during formation of a film, use of the dye may be limited. In recent years, in order to address such problems, it has been required to use a low boiling point solvent as a solvent component of a liquid crystal aligning agent in some cases. However, solvents having sufficiently high solubility with respect to a polymer component of a liquid crystal aligning agent and a sufficiently low boiling point are actually limited. In addition, when a polymer component is not uniformly dissolved in a solvent, there are concerns of the occurrence of coating irregularities (the irregular film thickness) and pinholes in a liquid crystal alignment film formed on the substrate and linearity not being secured at an end of a coating area and a flat surface not being obtained. In this case, there is a risk of a product yield decreasing, and display performance such as liquid crystal alignment properties, electrical characteristics, and the like being influenced.

Therefore, as a polymer component of the liquid crystal aligning agent, a new material which exhibits high solubility with respect to a low boiling point solvent and exhibits favorable coating properties with respect to a substrate and has excellent liquid crystal alignment properties and electrical characteristics when used for a liquid crystal aligning agent is required. In particular, in recent years, as large-screen and high definition liquid crystal televisions have become mainstream and small display terminals such as smartphones and tablet PCs have become widespread, the demand for higher-quality liquid crystal panels has been further increasing. Therefore, it is important to secure excellent display quality.

The present disclosure has been made in view of the above circumstances, and an objective of the present disclosure is to provide a liquid crystal aligning agent with which it is possible to obtain a liquid crystal element in which coating properties with respect to a substrate are favorable and liquid crystal alignment properties and a voltage holding ratio are excellent.

### Solution to Problem

According to the present disclosure, the following aspects are provided.

[1] A liquid crystal aligning agent including the following polymer (A) and polymer (B),

(A) the polymer having at least one structural unit U1 selected from the group consisting of a structural unit represented by the following Formula (1) and a structural unit represented by the following Formula (2), and a structural unit U2 derived from at least one monomer selected from the group consisting of styrene monomers and (meth)acrylic monomers; and

(B) at least one polymer selected from the group consisting of a polyamic acid, a polyamic acid ester and a polyimide.

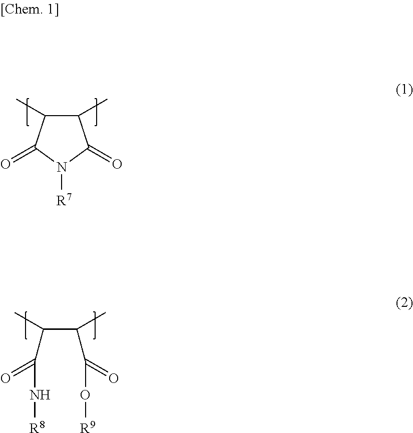

(In Formula (1), R⁷ is a monovalent organic group having 1 or more carbon atoms; and in Formula (2), R⁸ is a monovalent organic group having 1 or more carbon atoms, and R⁹ is a hydrogen atom or a monovalent organic group having 1 or more carbon atoms.)

[2] A liquid crystal alignment film formed using the liquid crystal aligning agent according to [1].

[3] A liquid crystal element including the liquid crystal alignment film according to [2].

### Advantageous Effects of Invention

According to the liquid crystal aligning agent including the polymer (A) and the polymer (B), it is possible to obtain a liquid crystal element in which liquid crystal alignment properties and a voltage holding ratio are excellent. In addition, the liquid crystal aligning agent has excellent coating properties with respect to a substrate and thus it is possible to prevent a product yield from decreasing. In particular, even if a low boiling point solvent is used as a solvent component, suitably, it is possible to obtain a liquid crystal element having excellent coating properties with respect to a substrate (reducing the irregular film thickness and pinholes, and securing linearity and flatness at an end of a coating area) and having both favorable liquid crystal alignment properties and electrical characteristics.

### DESCRIPTION OF THE EMBODIMENTS

### <<Liquid Crystal Aligning Agent>>

A liquid crystal aligning agent of the present disclosure includes the following polymer (A) and polymer (B). Hereinafter, components contained in the liquid crystal aligning agent of the present disclosure and other components that are optionally added as necessary will be described.

### <Polymer (A)>

The polymer (A) includes at least one structural unit U1 selected from the group consisting of a structural unit represented by Formula (1) and a structural unit represented by Formula (2), and a structural unit U2 derived from at least one monomer selected from the group consisting of styrene monomers and (meth)acrylic monomers.

(Structural unit U1)

The structural unit U1 is a structural unit derived from a compound having a maleimide group (hereinafter referred to as a “maleimide compound”) or maleic anhydride. However, in a case of the structural unit U1 is a structural unit derived from maleic anhydride, the structural unit derived from maleic anhydride is introduced into a polymer and then reacts with an amino-group-containing compound, and thereby a polymer having the structural unit U1 is obtained. Here, in this specification, “maleimide group” refers to a group in which a hydrogen atom bonded to a nitrogen atom in maleimide is removed (a group represented by the following Formula (z-1-1)) or a group having a structure derived from a ring-opened form of maleimide (a group represented by the following Formula (z-4-1)).

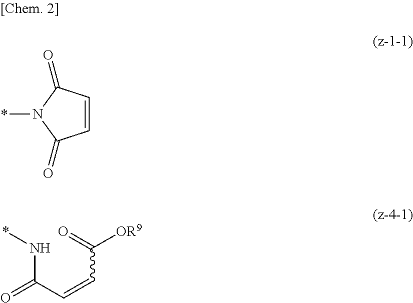

(In the expression, R⁹ is a hydrogen atom or a monovalent organic group having 1 or more carbon atoms; “*” represents a binding site; and the wave line in Formula (z-4-1) represents that an isomer structure is arbitrary.)

In Formula (1) and Formula (2), examples of monovalent organic groups of R⁷, R⁸ and R⁹ include a monovalent hydrocarbon group having 1 to 30 carbon atoms, a group in which at least one methylene group of the hydrocarbon group is substituted with —O—, —CO—, —COO— or —NR¹⁶— (wherein R¹⁶ is a hydrogen atom or a monovalent hydrocarbon group) (hereinafter referred to as a “group a”), a group in which at least one hydrogen atom of a monovalent hydrocarbon group having 1 to 30 carbon atoms or the group cc is substituted with a fluorine atom or a cyano group, a monovalent group having a photoalignable group, and a group having a crosslinkable group.

Here, in this specification, the term “hydrocarbon group” refers to chain hydrocarbon groups, alicyclic hydrocarbon groups, and aromatic hydrocarbon groups. “Chain hydrocarbon group” refers to linear hydrocarbon groups and branched hydrocarbon groups which do not have a ring structure in the main chain and are formed of only a chain structure. However, the group may be saturated or unsaturated. “Alicyclic hydrocarbon group” refers to hydrocarbon groups having only an alicyclic hydrocarbon structure as a ring structure without an aromatic ring structure. However, the alicyclic hydrocarbon group does not need to be formed of only an alicyclic hydrocarbon structure and it may have a chain structure in a part thereof. “Aromatic hydrocarbon group” refers to hydrocarbon groups having an aromatic ring structure as a ring structure. However, the aromatic hydrocarbon group does not need to be formed of only an aromatic ring structure but it may have a chain structure or an alicyclic hydrocarbon structure in a part thereof.

A content proportion of the structural unit U1 in the polymer (A) is preferably 2 to 90 mol %, more preferably 5 to 85 mol %, and most preferably 10 to 80 mol % with respect to a total amount of structural units derived from monomers constituting the polymer (A).

### (Structural Unit U2)

The structural unit U2 is introduced into the polymer (A) using at least one monomer selected from the group consisting of styrene monomers and (meth)acrylic monomers in a part of a polymerization monomer. The styrene monomer is a compound having a group obtained by removing at least one hydrogen atom from a substituted or unsubstituted benzene ring of styrene, and is preferably a group represented by the following Formula (z-5-1). A (meth)acryloyl group of a (meth)acrylic monomer is an “acryloyl group” or a “methacryloyl group.”

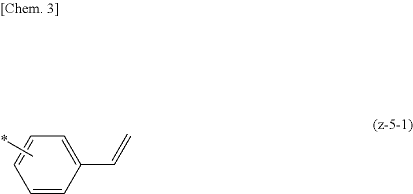

(In the expression, “*” represents a binding site.)

In a case of the structural unit U2 is a structural unit derived from a styrene monomer, a styrene-maleimide copolymer is obtained as the polymer (A). In a case of the structural unit U2 is a structural unit derived from a (meth)acrylic monomer, a (meth)acryl-maleimide copolymer is obtained as the polymer (A). In addition, in a case of the structural unit U2 is formed of a structural unit derived from a styrene monomer and a structural unit derived from a (meth)acrylic monomer, a styrene-(meth)acryl-maleimide copolymer is obtained as the polymer (A). As the polymer (A), among these, a styrene-maleimide polymer is preferable because it makes it possible to obtain a liquid crystal element having excellent coating properties with respect to a substrate and a further improved voltage holding ratio.

A content proportion of the structural unit U2 in the polymer (A) is preferably 2 to 90 mol %, more preferably 5 to 85 mol %, and most preferably 10 to 80 mol % with respect to a total amount of structural units derived from monomers constituting the polymer (A).

The polymer (A) may further have a structural unit (hereinafter referred to as “other structural unit”) different from the structural unit U1 and the structural unit U2. The other structural unit is not particularly limited, and examples thereof include a structural unit derived from a conjugated diene compound. Here, the polymer (A) may include only one type of structural unit derived from the other monomer or two or more types thereof. A content proportion of the other structural unit in the polymer (A) is preferably 10 mol % or less and more preferably 5 mol % or less with respect to a total amount of structural units derived from monomers constituting the polymer (A).

In order to obtain sufficient effects of the present disclosure, the polymer (A) preferably has at least one functional group of the following (x1) to (x3) on a side chain. Among these, the polymer (A) preferably has at least (x1) and particularly preferably has all of (x1) to (x3).

(x1) Photoalignable group.

(x2) At least one functional group of an oxetanyl group and an oxiranyl group.

(x3) Functional group which reacts with at least one of an oxetanyl group and an oxiranyl group by heating (hereinafter referred to as a “reactive functional group”).

Here, each of the functional groups may be incorporated into any structural unit of the structural unit U1, the structural unit U2, and the other structural unit. In addition, each of the functional groups may be incorporated into only one structural unit of the structural unit U1, the structural unit U2, and the other structural unit, or may be incorporated into two or more structural units. Hereinafter, the functional groups will be described in detail.

### (x1) Photoalignable Group

In a case of the polymer (A) has a photoalignable group, the photoalignable group is preferably a functional group that imparts anisotropy to a film according to photoisomerization, a photo dimerization reaction, an optical Fries rearrangement reaction or a photolysis reaction due to light emission.

Specific examples of the photoalignable group of the polymer (A) include, for example, an azobenzene-containing group having azobenzene or its derivative as a basic skeleton, a cinnamic-acid-structure-containing group having cinnamic acid or its derivative (cinnamic acid structure) as a basic skeleton, a chalcone-containing group having chalcone or its derivative as a basic skeleton, a benzophenone-containing group having benzophenone or its derivative as a basic skeleton, a coumarin-containing group having coumarin or its derivative as a basic skeleton, and a cyclobutane-containing structure having cyclobutane or its derivative as a basic skeleton. Among these, the photoalignable group is preferably a cinnamic-acid-structure-containing group and specifically, is preferably a group having a cinnamic acid structure represented by the following Formula (6) as a basic skeleton because it has high sensitivity with respect to light and is easily introduced into a polymerside chain.

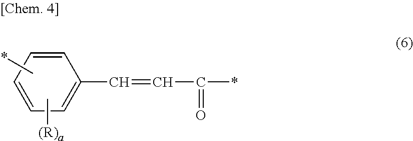

(In Formula (6), R is an alkyl group having 1 to 10 carbon atoms which optionally has a fluorine atom or a cyano group, an alkoxy group having 1 to 10 carbon atoms which optionally has a fluorine atom or a cyano group, a fluorine atom, or a cyano group; a is an integer of 0 to 4; when a is 2 or more, a plurality of R's may be the same or different from each other; and “*” represents a binding site.)

In the structure represented by Formula (6), it is preferable that one of two binding sites “*” be bonded to a group represented by the following Formula (4). This case is suitable because it is possible to further improve liquid crystal alignment properties of the obtained liquid crystal element.

[Chem. 5]

H—R¹¹—R¹²—* (4)

(In Formula (4), R¹¹ is a phenylene group, a biphenylene group, a terphenylene group or a cyclohexylene group, and may have, in a ring part, an alkyl group having 1 to 10 carbon atoms, an alkoxy group having 1 to 10 carbon atoms, an alkyl group having 1 to 10 carbon atoms in which at least one hydrogen atom is substituted with a fluorine atom or a cyano group, an alkoxy group having 1 to 10 carbon atoms in which at least one hydrogen atom is substituted with a fluorine atom or a cyano group, a fluorine atom, or a cyano group; when R¹² is bonded to a phenyl group in Formula (6), it is a single bond, an alkanediyl group having 1 to 3 carbon atoms, an oxygen atom, a sulfur atom, —CH═CH—, —NH—, —COO—, or —OCO—; when R¹² is bonded to a carbonyl group in Formula (6), it is a single bond, an alkanediyl group having 1 to 3 carbon atoms, oxygen atom, sulfur atom, or —NH—; and “*” represents a binding site.)

Regarding the photoalignable group, the structural unit U1 preferably has a photoalignable group in order to obtain a sufficient effect of improving electrical characteristics of the obtained liquid crystal element. A content proportion of the photoalignable group is preferably 1 to 70 mol % and more preferably 3 to 60 mol % with respect to a total amount of the structural unit U1, the structural unit U2, and the other structural unit of the polymer (A).

### (x2) Oxetanyl Group and Oxiranyl Group

The polymer (A) preferably has at least one of an oxetanyl group and an oxiranyl group (hereinafter simply referred to as an “epoxy group”) because it is possible to obtain a liquid crystal alignment film that exhibits excellent liquid crystal alignment properties even if a firing temperature when an alignment film is formed is low. The epoxy group is preferably an oxiranyl group because it has high reactivity.

The epoxy group is preferably contained in the structural unit U2 because it is easy to adjust an amount of the epoxy group introduced and a degree of freedom in selection of a monomer is high. A content proportion of the epoxy group is preferably 1 to 70 mol % and more preferably 5 to 60 mol % with respect to a total amount of the structural unit U1, the structural unit U2, and the other structural unit of the polymer (A).

### (x3) Reactive Functional Group

In order to obtain a sufficient effect of improving liquid crystal alignment properties (in particular, an effect of improving liquid crystal alignment properties when firing is performed at a low temperature), preferably, the polymer (A) further has a reactive functional group together with an epoxy group (x2). Examples of the reactive functional group include a carboxyl group, a hydroxyl group, an isocyanate group, and an amino group, a group in which these groups are protected with a protecting group, and an alkoxymethyl group. Among these, the reactive functional group is preferably at least one selected from the group consisting of a carboxyl group and a protected carboxyl group (hereinafter referred to as a “protected carboxyl group”) because it has favorable storage stability and high reactivity with an oxetane ring and an oxirane ring by heating.

The protected carboxyl group is not particularly limited as long as it is separated due to heat and generates a carboxyl group. Specific examples of the protected carboxyl group preferably include a structure represented by the following Formula (3), an acetal ester structure of a carboxylic acid, and a ketal ester structure of a carboxylic acid.

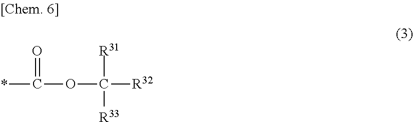

(In Formula (3), R³¹, R³² and R³³ are independently an alkyl group having 1 to 10 carbon atoms or a monovalent alicyclic hydrocarbon group having 3 to 10 carbon atoms, or, R³¹ and R³² are bonded to each other and form a divalent alicyclic hydrocarbon group or cyclic ether group having 4 to 20 carbon atoms together with carbon atoms to which R³¹ and R³² are bonded, and R³³ is an alkyl group having 1 to 10 carbon atoms, an alkenyl group having 2 to 10 carbon atoms or an aryl group having 6 to 20 carbon atoms; and “*” represents a binding site.)

The reactive functional group is preferably contained in the structural unit U1 because it is possible to obtain an effect of improving coating properties with respect to a substrate and it is possible to introduce a sufficient amount of the reactive functional group, and is preferably contained in the structural unit U2 because a degree of freedom in selection of a monomer is high and it is easy to adjust an amount of the reactive functional group introduced. A content proportion of the reactive functional group is preferably 1 to 90 mol % and more preferably 5 to 90 mol % with respect to a total amount of the structural unit U1, the structural unit U2, and the other structural unit of the polymer (A).

### (Synthesis of Polymer)

A method of synthesizing the polymer (A) is not particularly limited, and synthesis can be performed by appropriately combining organic chemistry methods. In a case of a polymer having a photoalignable group, an epoxy group and a reactive functional group is obtained as the polymer (A), the following Method 1, Method 2, Method 3, and the like are used.

(Method 1): a method in which polymerization monomers including a maleimide compound and at least one selected from the group consisting of a styrene monomer and a (meth)acrylic monomer and having a photoalignable group, an epoxy group, and a reactive functional group in the same or different molecules are polymerized.

(Method 2): a method in which polymerization monomers including a maleimide compound and at least one selected from the group consisting of a styrene monomer and a (meth)acrylic monomer and having an epoxy group and a reactive functional group in the same or different molecules are polymerized to obtain a copolymer as a precursor, and next, the obtained precursor and a reactive compound having a photoalignable group are then reacted so that the photoalignable group is introduced into the copolymer.

(Method 3): a method in which polymerization monomers including maleic anhydride and at least one selected from the group consisting of a styrene monomer and a (meth)acrylic monomer and having an epoxy group and a reactive functional group in the same or different molecules are polymerized to obtain a copolymer including a structural unit derived from maleic anhydride and a structural unit derived from at least one monomer selected from the group consisting of styrene monomers and (meth)acrylic monomers as a precursor, and next, the obtained precursor and an amino-group-containing compound having a photoalignable group are then reacted (refer to the scheme in the following Formula (7)).

Among them, Method 1 is preferably used because a photoalignable group, an epoxy group and a reactive functional group are introduced into a side chain of the polymer with high efficiency and simply.

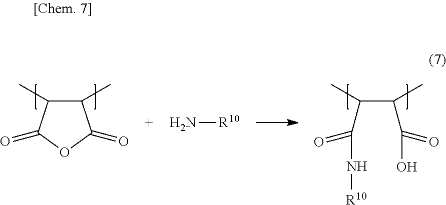

(In Formula (7), R¹⁰ is a monovalent organic group having a photoalignable group.)

In Method 1, the structural unit U1 is introduced into the polymer (A) due to the maleimide compound and the structural unit U2 is introduced into the polymer (A) due to at least one of a styrene monomer and a (meth)acrylic monomer. More specifically, as the maleimide compound, at least one selected from the group consisting of a compound represented by the following Formula (1A) and a compound represented by the following Formula (2A) is used, and monomer groups including one, two or more thereof and at least one selected from the group consisting of a styrene monomer and a (meth)acrylic monomer are preferably polymerized.

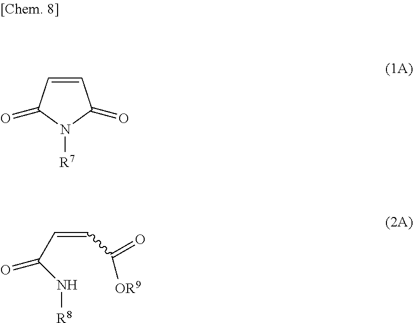

(R⁷ in Formula (1A) has the same meaning as in Formula (1), and R⁸ and R⁹ in Formula (2A) have the same meanings as in Formula (2); and the wavy line in Formula (2A) indicates that the isomer structure is arbitrary.)

According to Method 1, in a case of a polymer having a photoalignable group, an epoxy group and a reactive functional group is obtained as the polymer (A), in order to increase efficiency of introducing an photoalignable group, an epoxy group and a reactive functional group, for the polymerization monomers, preferably, a photoalignable group, an epoxy group and a reactive functional group are provided in different compounds. That is, for the polymerization monomers, preferably, a monomer (m1) having an epoxy group, a monomer (m2) having a reactive functional group, and a monomer (m3) having a photoalignable group are used for polymerization.

Specific examples of the monomer (m1) having an epoxy group include, as a maleimide monomer, for example, N-(4-glycidyloxyphenyl)maleimide, and N-glycidyl maleimide;

as a styrene monomer, for example, 3-(glycidyloxymethyl)styrene, 4-(glycidyloxymethyl)styrene, and 4-glycidyl-α-methyl styrene; and

as a (meth)acrylic monomer, for example, glycidyl(meth)acrylate, glycidyl α-ethylacrylate, α-n-propyl glycidyl acrylate, α-n-butyl acrylate glycidyl, (meth)acrylate 3,4-epoxybutyl, α-ethyl acrylate 3,4-epoxy butyl, 3,4-epoxycyclohexylmethyl(meth)acrylate, 6,7-epoxyheptyl(meth)acrylate, α-ethyl acrylate 6,7-epoxyheptyl, 4-hydroxybutyl glycidyl ether acrylate, and (3-ethyloxetan-3-yl)methyl(meth)acrylate.

Here, as the monomer (m1), one thereof may be used alone or two or more thereof may be used in combination.

Specific examples of the monomer (m2) having a reactive functional group include, as a maleimide compound, for example, 3-(2,5-dioxo-3-pyrrolin-1-yl)benzoate, 4-(2,5-dioxo-3-pyrrolin-1-yl)benzoate, and methyl 4-(2,5-dioxo-3-pyrrolin-1-yl)benzoate;

as a styrene monomer, for example, 3-vinylbenzoic acid, and 4-vinylbenzoic acid; and

as a (meth)acrylic monomer, for example, a carboxyl-group-containing compound such as (meth)acrylic acid, α-ethyl acrylic acid, maleic acid, fumaric acid, vinylbenzoic acid, crotonic acid, citraconic acid, mesaconic acid, itaconic acid, 3-maleimidobenzoic acid, and 3-maleimidopropionic acid; an unsaturated polycarboxylic anhydride such as maleic anhydride; and protected carbonyl-group-containing compounds represented by the following Formula (m2-1) to Formula (m2-12):

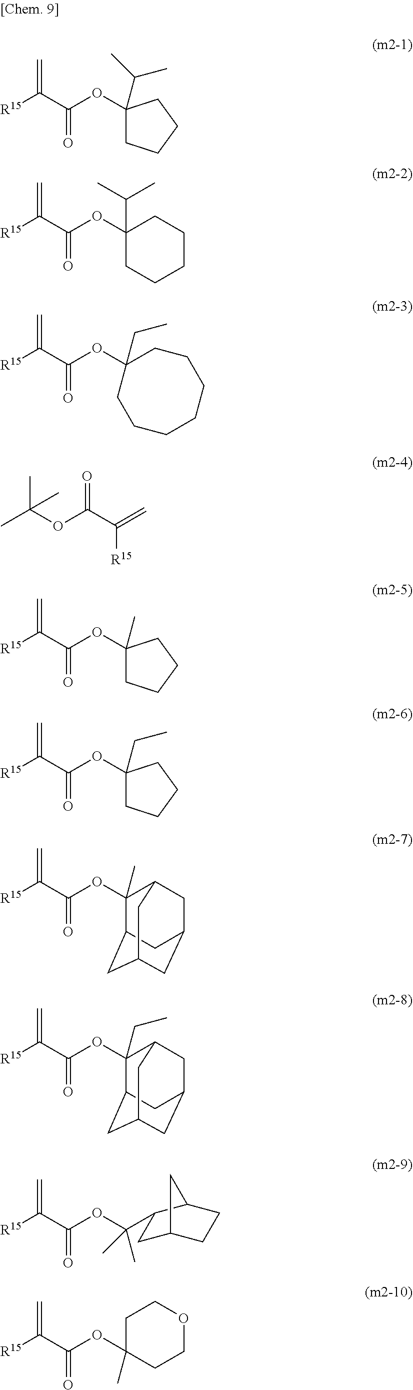

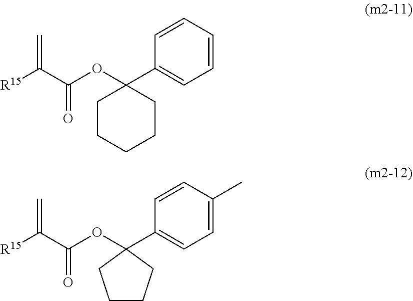

(in Formula (m2-1) to Formula (m2-12), R¹⁵ is a hydrogen atom or a methyl group).

Here, as the monomer (m2), one thereof can be used alone or two or more thereof can be used in combination.

Examples of the monomer (m3) having a photoalignable group include a compound represented by the following Formula (5):

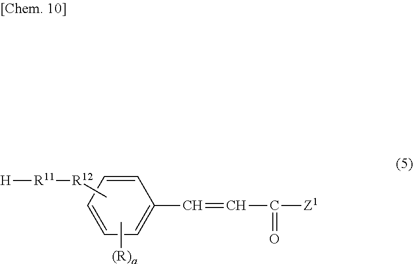

(in Formula (5), Z¹ is a monovalent organic group having a polymerizable unsaturated bond; R and a have the same meanings as in Formula (6), and R¹¹ and R¹² have the same meanings as in Formula (4)).

Z¹ in Formula (5) is preferably any one of the following Formula (z-1) to Formula (z-5).

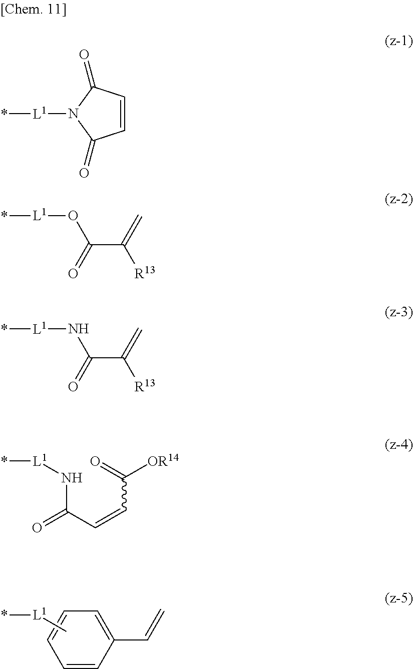

(In the expression, L¹ is a divalent linking group. R¹³ is a hydrogen atom or a methyl group; R¹⁴ is a hydrogen atom or a monovalent organic group having 1 or more carbon atoms; “*” represents a binding site; and the wavy line in Formula (z-4) indicates that the isomer structure is arbitrary.)

In Formula (z-1) to Formula (z-5), the divalent linking group of L¹ is preferably a divalent hydrocarbon group having 1 to 20 carbon atoms or a group in which at least one methylene group of the hydrocarbon group is substituted with —O—, —CO—, or —COO—. Specific examples of a hydrocarbon group of L¹ include a divalent chain hydrocarbon group, an alicyclic hydrocarbon group, and an aromatic hydrocarbon group.

For the monovalent organic group of R¹⁴, descriptions of the monovalent organic group of R⁹ in Formula (2) apply similarly. In order to enhance an effect of improving coating properties, R¹⁴ is preferably a hydrogen atom or a monovalent hydrocarbon group having 1 to 6 carbon atoms, more preferably a hydrogen atom or an alkyl group having 1 to 3 carbon atoms, and particularly preferably a hydrogen atom.

In order to obtain a liquid crystal element having superior electrical characteristics and liquid crystal alignment properties, Z¹ in Formula (5) is more preferably a group represented by Formula (z-1) or Formula (z-4).

Specific examples of the monomer (m3) having a photoalignable group include, as a maleimide compound, for example, compounds represented by the following Formula (m3-1) to Formulae (m3-5), and (m3-11) to (m3-13);

as a styrene monomer, for example, a compound represented by the following Formula (m3-9); and

as a (meth)acrylic monomer, for example, compounds represented by the following Formula (m3-6) to Formulae (m3-8), and (m3-10).

As the monomer (m3), one thereof can be used alone or two or more thereof can be used in combination. Here, isomer structures of the following Formula (m3-4) and Formula (m3-5) are arbitrary, and include a trans form and a cis form.

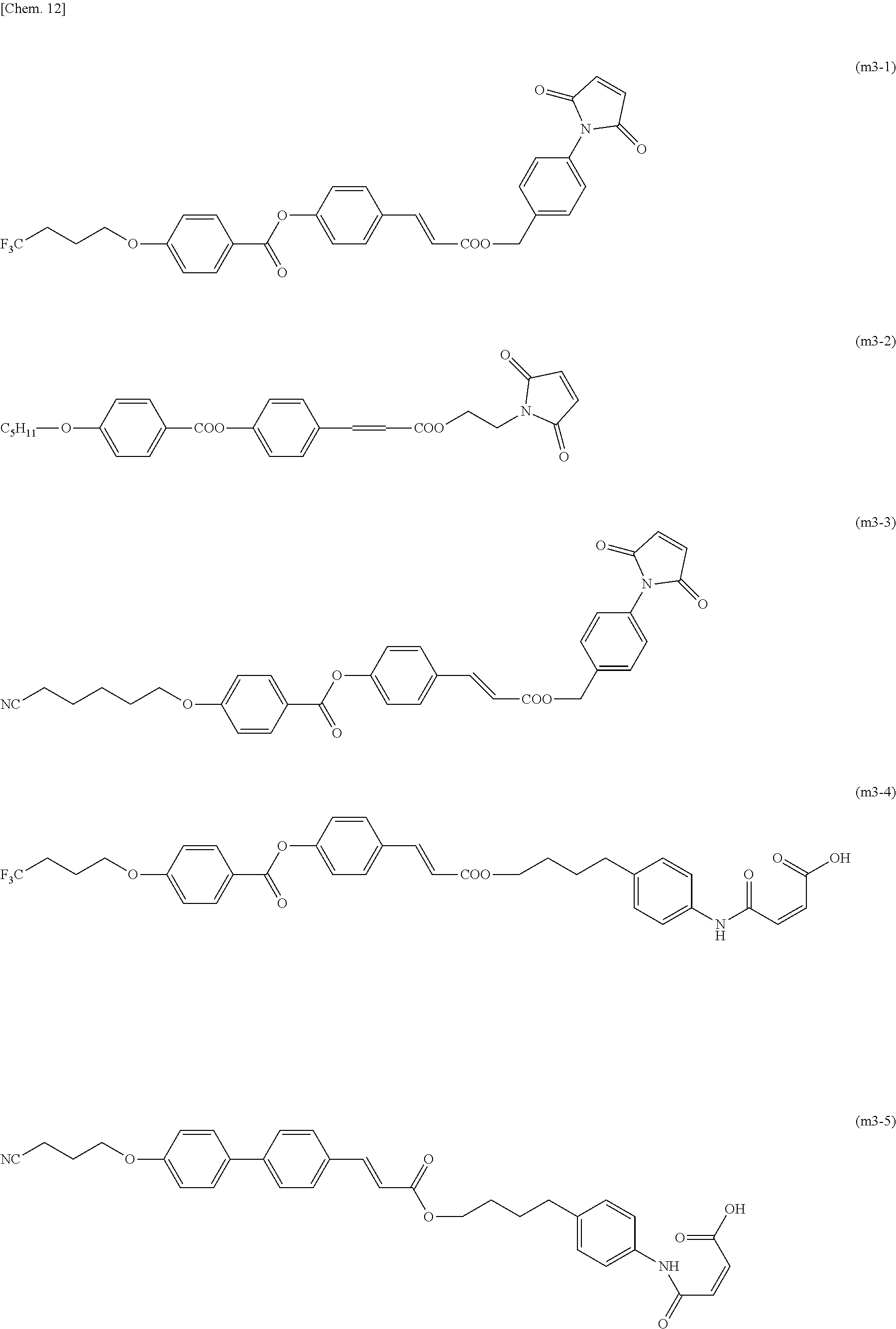

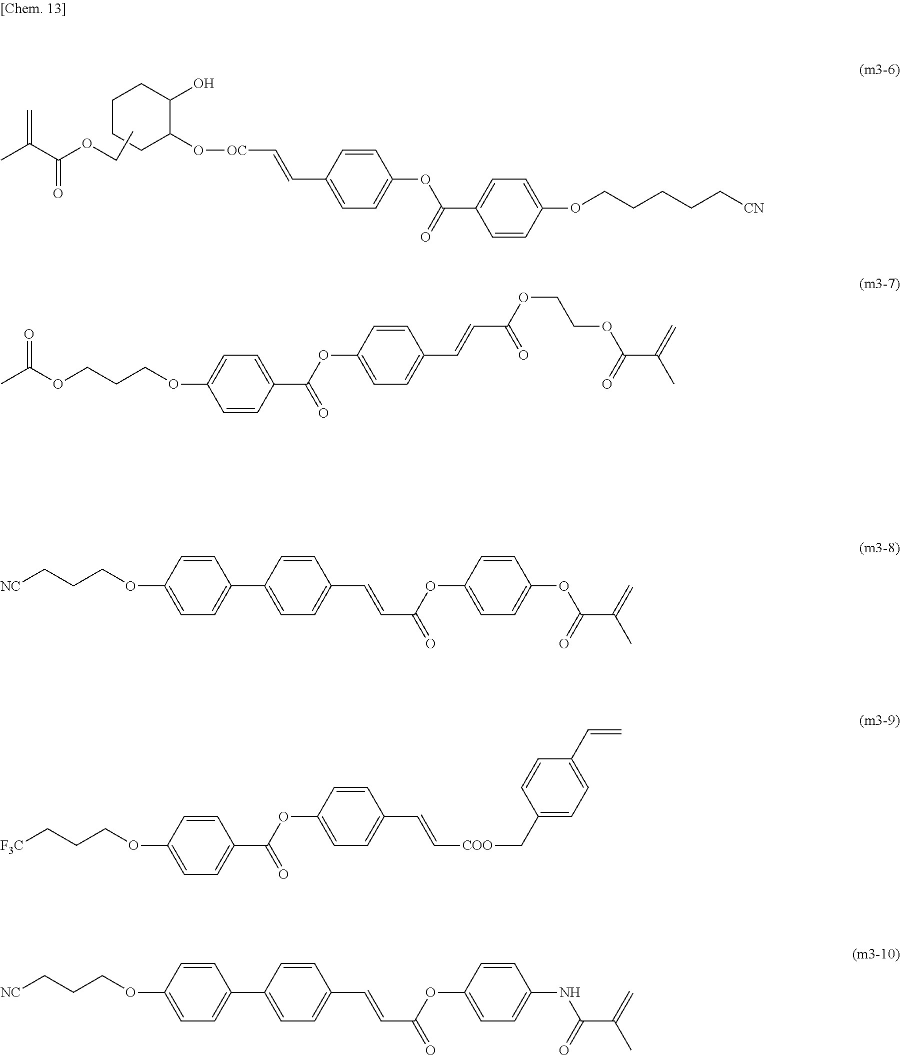

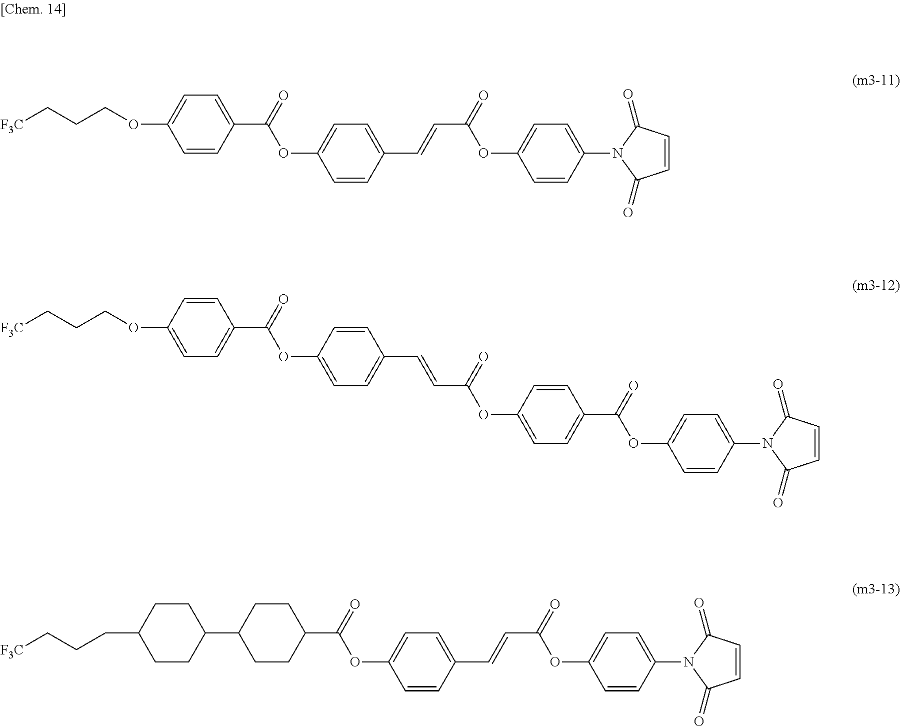 [SMILES: O=C(/C=C/c1ccc(OC(=O)c2ccc(OCCCC(F)(F)F)cc2)cc1)Oc1ccc(N2C(=O)C=CC2=O)cc1 ; O=C(/C=C/c1ccc(OC(=O)c2ccc(OCCCC(F)(F)F)cc2)cc1)Oc1ccc(C(=O)Oc2ccc(N3C(=O)C=CC3=O)cc2)cc1 ; O=C(/C=C/c1ccc(OC(=O)C2CCC(C3CCC(CCCC(F)(F)F)CC3)CC2)cc1)Oc1ccc(N2C(=O)C=CC2=O)cc1]

Here, as the monomer (m3) having a photoalignable group, a monomer (m3-f1) having a fluorine atom and a monomer (m3-n1) having no fluorine atom may be used.

In a case of synthesizing the polymer (A), a proportion of the monomer (m1) having an epoxy group used is preferably 1 to 70 mol %, more preferably 5 to 60 mol %, and most preferably 10 to 55 mol % with respect to a total amount of monomers used for synthesizing the polymer (A).

In addition, a proportion of the monomer (m2) having a reactive functional group used is preferably 1 to 90 mol %, more preferably 5 to 90 mol %, and most preferably 10 to 80 mol % with respect to a total amount of monomers used for synthesizing the polymer (A).

A content proportion of the monomer (m3) having a photoalignable group is preferably 1 to 70 mol %, more preferably 3 to 60 mol %, and most preferably 5 to 60 mol % with respect to a total amount of monomers used for synthesizing the polymer (A).

In the polymerization, a monomer having none of a photoalignable group, an epoxy group and a reactive functional group (hereinafter referred to as “other monomer”) may be used together. Examples of the other monomer include a (meth)acrylic compound such as alkyl(meth)acrylate, cycloalkyl(meth)acrylate, benzyl(meth)acrylate, and 2-ethylhexyl(meth)acrylate; an aromatic vinyl compound such as styrene, methyl styrene, and divinylbenzene; a conjugated diene compound such as 1,3-butadiene, and 2-methyl-1,3-butadiene; and a maleimide compound such as N-methyl maleimide, N-cyclohexyl maleimide, and N-phenyl maleimide. Here, the other monomer can be used alone or two or more thereof can be used in combination. A proportion of the other monomer used is preferably 30 mol % or less and more preferably 20 mol % or less with respect to a total amount of monomers used for synthesizing the polymer (A).

In the polymerization, a proportion of the maleimide compound used is preferably 2 to 90 mol % with respect to a total amount of monomers used for polymerizing the polymer (A). When the proportion is less than 2 mol %, it is difficult for the obtained polymer to obtain solubility with respect to a solvent and an effect of improving coating properties with respect to a substrate. On the other hand, when the proportion exceeds 90 mol %, the obtained liquid crystal element tends to have inferior liquid crystal alignment properties and a low voltage holding ratio. A proportion of the maleimide compound used is more preferably 5 to 85 mol % and most preferably 10 to 80 mol % with respect to a total amount of monomers used for polymerizing the polymer (A).

In order to secure sufficient liquid crystal alignment properties and electrical characteristics of the liquid crystal element, a proportion of the styrene monomer and the (meth)acrylic monomer used (a total amount when two or more thereof are used) is preferably 2 to 90 mol %, more preferably 5 to 85 mol %, and most preferably 10 to 80 mol % with respect to a total amount of monomers used for polymerizing the polymer (A).

Preferably, the polymerization reaction occurs in an organic solvent in the presence of a polymerization initiator. As the polymerization initiator used, for example, an azo compound such as 2,2′-azobis (isobutyronitrile),2,2′-azobis(2,4-dimethylvaleronitrile), and 2,2′-azobis(4-methoxy-2,4-dimethylvaleronitrile) is preferable. A proportion of the polymerization initiator used is preferably 0.01 to 30 parts by mass with respect to 100 parts by mass of all monomers used for a reaction. Examples of the organic solvent used include an alcohol, ether, ketone, amide, ester, and a hydrocarbon compound.

In the polymerization reaction, a reaction temperature is preferably 30° C. to 120° C., and a reaction time is preferably 1 to 36 hours. An amount (a) of the organic solvent used is preferably set so that a total amount (b) of monomers used for a reaction is 0.1 to 60 mass % with respect to a total amount (a+b) of the reaction solution. Using known isolation methods, for example, a method in which a reaction solution is poured into a large amount of a poor solvent and the obtained precipitate is dried under a reduced pressure and a method in which a reaction solution is distilled off under a reduced pressure in an evaporator, in the reaction solution obtained by dissolving polymers, the polymer (A) contained in the reaction solution may be isolated and then used for preparing a liquid crystal aligning agent.

A weight average molecular weight (Mw) of the polymer (A) in terms of polystyrene standards measured through gel permeation chromatography (GPC) is preferably 1,000 to 300,000 and more preferably 2,000 to 100,000. A molecular weight distribution (Mw/Mn) represented by a ratio of Mw to the number average molecular weight (Mn) in terms of polystyrene standards measured through GPC is preferably 10 or less and more preferably 8 or less. Here, the polymer (A) used for preparing a liquid crystal aligning agent may be used alone or two or more types thereof may be used in combination.

In order to sufficiently improve coating properties with respect to a substrate and obtain favorable liquid crystal alignment properties and a high voltage holding ratio of the liquid crystal element, a content proportion of the polymer (A) in the liquid crystal aligning agent is preferably 0.1 mass % or more, more preferably 0.5 mass % or more, and most preferably 1 mass % or more with respect to all polymers contained in the liquid crystal aligning agent. In addition, an upper limit value of the content proportion of the polymer (A) is not particularly limited, and is preferably 90 mass % or less, more preferably 70 mass % or less, and most preferably 50 mass % or less with respect to all polymers contained in the liquid crystal aligning agent.

### <Polymer (B)>

The polymer (B) is at least one selected from the group consisting of a polyamic acid, a polyamic acid ester and a polyimide. The polymer (B) can be synthesized according to a known method in the related art. For example, the polyamic acid can be obtained by reacting a tetracarboxylic acid dianhydride with a diamine. Here, in this specification, the term “tetracarboxylic acid derivative” includes a tetracarboxylic acid dianhydride, a tetracarboxylic acid diester and a tetracarboxylic acid diester dihalide.

The tetracarboxylic acid dianhydride used for polymerization is not particularly limited, and various tetracarboxylic acid dianhydrides can be used. Specific examples thereof include aliphatic tetracarboxylic acid dianhydrides such as butane tetracarboxylic dianhydride, and ethylene diamine tetraacetic acid dianhydride; alicyclic tetracarboxylic acid dianhydrides such as 1,2,3,4-cyclobutanetetracarboxylic acid dianhydride, 1,3-dimethyl-1,2,3,4-cyclobutanetetracarboxylic acid dianhydride, 2,3,5-tricarboxycyclopentyl acetic acid dianhydride, 5-(2,5-dioxotetrahydrofuran-3-yl)-3a,4,5,9b-tetrahydronaphtho [1,2-c] furan-1,3-dione, 5-(2,5-dioxotetrahydrofuran-3-yl)-8-methyl-3a,4,5,9b-tetrahydronaphtho [1,2-c] furan-1,3-dione, 2,4,6,8-tetracarboxybicyclo [3.3.0] octane-2: 4,6: 8-dianhydride, cyclopentane tetracarboxylic acid dianhydride, and cyclohexane tetracarboxylic acid dianhydride; and aromatic tetracarboxylic acid dianhydrides such as pyromellitic dianhydride, 4,4′-(hexafluoroisopropylidene)diphthalic anhydride, p-phenylenebis (trimellitic acid monoester anhydride), ethylene glycol bis(anhydrotrimellitate), and 1,3-propylene glycol bis(anhydrotrimellitate), and in addition, tetracarboxylic acid dianhydrides described in Japanese Unexamined Patent Application Publication No. 2010-97188 can be used. Here, the tetracarboxylic acid dianhydride may be used alone or two or more thereof may be used in combination.

In order to further improve solubility of the polymer (B) with respect to a solvent, improve coating properties, and control phase separation properties for the polymer (A), the tetracarboxylic acid dianhydride used in polymerization preferably includes an alicyclic tetracarboxylic acid dianhydride, and more preferably includes a tetracarboxylic acid dianhydride having a cyclobutane ring, a cyclopentane ring or a cyclohexane ring. A proportion of the alicyclic tetracarboxylic acid dianhydride used is preferably 5 mol % or more, more preferably 10 mol % or more, and most preferably 20 mol % or more with respect to a total amount of the tetracarboxylic acid dianhydride used in polymerization. Here, when an alicyclic tetracarboxylic acid dianhydride is used in the reaction, a polyamic acid having a structural unit derived from the alicyclic tetracarboxylic acid dianhydride can be obtained as the polymer (B).

Examples of the diamine used in the polymerization include an aliphatic diamine such as ethylene diamine and tetramethylene diamine; an alicyclic diamine such as p-cyclohexane diamine, and 4,4′-methylenebis(cyclohexylamine); a side chain type aromatic diamine such as hexadecanoxydiaminobenzene, colestanyloxy diaminobenzene, cholestanil diaminobenzoate, cholesteryl diaminobenzoate, ranostanil diaminobenzoate, 3,6-bis(4-aminobenzoyloxy)cholestane, 3,6-bis(4-aminophenoxy)cholestane, 1,1-bis(4-((aminophenyl)methyl)phenyl)-4-butylcyclohexane, 2,5-diamino-N,N-diallylaniline, and compounds represented by the following Formula (2-1) to Formula (2-3):

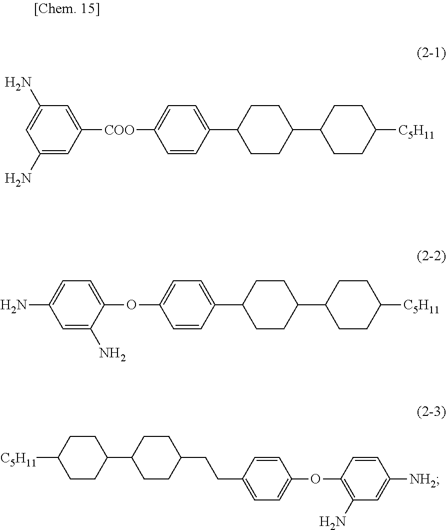

a non-side chain type aromatic diamine such as p-phenylene diamine, 4,4′-diaminodiphenylmethane, 4,4′-diaminodiphenylamine, 4-aminophenyl-4′-aminobenzoate, 4,4′-diamino azobenzene, 3,5-diaminobenzoic acid, 1,5-bis(4-aminophenoxy)pentane, bis[2-(4-aminophenyl)ethyl] hexanedioic acid, bis(4-aminophenyl)amine, N,N-bis(4-aminophenyl)methylamine, N,N′-bis(4-aminophenyl)-benzidine, 2,2′-dimethyl-4,4′-diaminobiphenyl, 2,2′-bis(trifluoromethyl)-4,4′-diaminobiphenyl, 4,4′-diaminodiphenyl ether, 2,2-bis[4-(4-aminophenoxy) phenyl]propane, 4,4′-(phenylenediisopropylidene)bisaniline, 1,4-bis(4-aminophenoxy)benzene, 4-(4-aminophenoxycarbonyl)-1-(4-aminophenyl)piperidine, and 4,4′-[4,4′-propane-1,3-diylbis(piperidine-1,4-diyl)]dianiline; and a diaminoorganosiloxane such as 1,3-bis(3-aminopropyl)-tetramethyldisiloxane, and in addition, diamines described in Japanese Unexamined Patent Application Publication No. 2010-97188 can be used. Here, the diamine may be used alone or two or more thereof may be used in combination.

In order to further improve solubility of the polymer (B) with respect to a solvent, improve coating properties, and control phase separation properties for the polymer (A), the diamine used in synthesizing preferably includes a diamine compound having a carboxyl group (hereinafter referred to as a “carboxyl-group-containing diamine”).

The carboxyl-group-containing diamine may have at least one carboxyl group and two amino groups in the molecule, and the remaining structure is not particularly limited. Specific examples of the carboxyl-group-containing diamine include a monocarboxylic acid such as 3,5-diaminobenzoic acid, 2,4-diaminobenzoic acid, 2,5-diaminobenzoic acid, 4,4′-diaminobiphenyl-3-carboxylic acid, 4,4′-diaminodiphenylmethane-3-carboxylic acid, and 4,4′-diaminodiphenylethane-3-carboxylic acid; and a dicarboxylic acid such as 4,4′-diaminobiphenyl-3,3′-dicarboxylic acid, 4,4′-diaminobiphenyl-2,2′-dicarboxylic acid, 3,3′-diaminobiphenyl-4,4′-dicarboxylic acid, 3,3′-diaminobiphenyl-2,4′-dicarboxylic acid, 4,4′-diaminodiphenylmethane-3,3′-dicarboxylic acid, 4,4′-diaminodiphenylethane-3,3′-dicarboxylic acid, and 4,4′-diaminodiphenyl ether-3,3′-dicarboxylic acid.

A proportion of the carboxyl-group-containing diamine used when a polyamic acid is synthesized is preferably 1 mol % or more, more preferably 5 mol % or more, and most preferably 10 mol % or more with respect to a total amount of the diamine used in synthesizing. In addition, an upper limit value of the use proportion is not particularly limited, but it is preferably 90 mol % or less and more preferably 80 mol % or less with respect to a total amount of the diamine used in synthesizing in order to prevent a voltage holding ratio from decreasing. Here, the carboxyl-group-containing diamine may be used alone or two or more thereof can be appropriately selected and used.

### (Synthesis of Polyamic Acid)

A synthesis reaction of a polyamic acid preferably occurs in an organic solvent. A reaction temperature in this case is preferably −20° C. to 150° C., and a reaction time is preferably 0.1 to 24 hours. Examples of the organic solvent used in the reaction include an aprotic polar solvent, a phenol-based solvent, an alcohol, a ketone, an ester, an ether, a halogenated hydrocarbon, and a hydrocarbon. An amount of the organic solvent used is preferably set so that a total amount of the tetracarboxylic acid dianhydride and the diamine compound is 0.1 to 50 mass % with respect to a total amount of the reaction solution.

In a case of the polymer (B) is a polyamic acid ester, the polyamic acid ester can be obtained by, for example, a method in which the polyamic acid obtained above is reacted with an esterifying agent (for example, methanol, ethanol, and N,N-dimethylformamide diethyl acetal), a method in which a tetracarboxylic acid diester and a diamine compound are reacted in the presence of an appropriate dehydration catalyst, or a method in which a tetracarboxylic acid diester dihalide and a diamine are reacted in the presence of an appropriate base. In order to improve solubility of the polymer (B) with respect to a solvent and control phase separation properties for the polymer (A), the tetracarboxylic acid diester and the tetracarboxylic acid diester dihalide used in the reaction preferably include an alicyclic tetracarboxylic acid derivative. In addition, the diamine used in the reaction preferably includes a carboxyl-group-containing diamine.

In a case of the polymer (B) is a polyimide, the polyimide can be obtained by, for example, imidization of the polyamic acid obtained above according to dehydration and ring closure. An imidization ratio of the polyimide is preferably 20 to 95% and more preferably 30 to 90%. The imidization ratio is expressed as a percentage of a proportion of the number of imide ring structures with respect to a sum of the number of amic acid structures and the number of imide ring structures of the polyimide.

A weight average molecular weight (Mw) of the polymer (B) in terms of polystyrene standards measured through GPC is preferably 1,000 to 500,000 and more preferably 2,000 to 300,000. The molecular weight distribution (Mw/Mn) is preferably 7 or less and more preferably 5 or less. Here, the polymer (B) to be contained in the liquid crystal aligning agent may be used alone or two or more types thereof may be used in combination.

In order to exhibit coating properties with respect to a substrate, liquid crystal alignment properties, and electrical characteristics in a well-balanced manner, a proportion of the polymer (B) added is preferably 100 parts by mass or more with respect to 100 parts by mass of the polymer (A) used for preparing a liquid crystal aligning agent. A proportion of the polymer (B) added is more preferably 100 to 2,000 parts by mass and most preferably 200 to 1,500 parts by mass. Here, the polymer (B) may be used alone or two or more thereof may be used in combination.

### <Other Components>

The liquid crystal aligning agent of the present disclosure may include components other than the polymer (A) and the polymer (B) as necessary.

The other components are not particularly limited as long as effects of the present disclosure are not impaired. Specific examples of the other components include a polymer different from the polymer (A) and the polymer (B), a solvent, a low molecular compound having at least one epoxy group in the molecule and having a molecular weight of 1,000 or less (for example, ethylene glycol diglycidyl ether, N,N,N′,N′-tetraglycidyl-m-xylene diamine, and N,N,N′,N′-tetraglycidyl-4,4′-diaminodiphenylmethane), a functional silane compound, a multifunctional (meth)acrylate, an antioxidant, a metal chelate compound, a curing accelerator, a surfactant, a filler, a dispersant, and a photosensitizer. A proportion of the other components added can be appropriately selected according to compounds as long as effects of the present disclosure are not impaired.

The liquid crystal aligning agent of the present disclosure is prepared as a composition in a solution form in which a polymer component and a component which is optionally added as necessary are preferably dissolved in an organic solvent. Examples of the organic solvent include an aprotic polar solvent, a phenol-based solvent, an alcohol, ketone, ester, ether, halogenated hydrocarbon, and hydrocarbon. A solvent component may be one thereof or a solvent mixture containing two or more thereof.

### (Specific Solvent)

As a solvent component of the liquid crystal aligning agent of the present disclosure, a solvent with a boiling point of 180° C. or lower at 1 atmosphere (hereinafter referred to as a “specific solvent”) which is at least one selected from the group consisting of a compound represented by the following Formula (D-1), a compound represented by the following Formula (D-2) and a compound represented by the following Formula (D-3) can be preferably used. The specific solvent is preferably used as at least a part of the solvent component because it makes it possible to obtain a liquid crystal element having excellent liquid crystal alignment properties and electrical characteristics even if heating when a film is formed is performed at a low temperature (for example, 200° C. or lower).

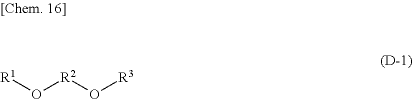

(In Formula (D-1), R¹ is an alkyl group having 1 to 4 carbon atoms or CH₃CO—, R² is an alkanediyl group having 1 to 4 carbon atoms or —(CH₂CH₂O)n-CH₂CH₂— (wherein n is an integer of 1 to 4), and R³ is a hydrogen atom or an alkyl group having 1 to 4 carbon atoms.)

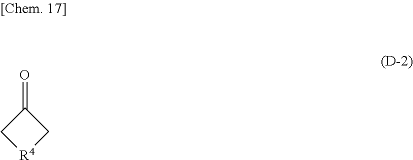

(In Formula (D-2), R⁴ is an alkanediyl group having 1 to 3 carbon atoms.)

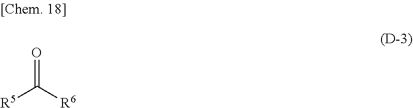

(In Formula (D-3), R⁵ and R⁶ are independently an alkyl group having 4 to 8 carbon atoms.)

Specific examples of the specific solvent include, as a compound represented by Formula (D-1), for example, propylene glycol monomethyl ether, propylene glycol monomethyl ether acetate, diethylene glycol methyl ethyl ether, 3-methoxy-1-butanol, ethylene glycol monomethyl ether, ethylene glycol monoethyl ether, ethylene glycol monopropyl ether, ethylene glycol-n-butyl ether (butyl cellosolve), ethylene glycol dimethyl ether, ethylene glycol ethyl ether acetate, and diethylene glycol dimethyl ether;

as a compound represented by Formula (D-2), for example, cyclobutanone, cyclopentanone, and cyclohexanone; and

as a compound represented by Formula (D-3), for example, diisobutyl ketone. Here, the specific solvent may be used alone or two or more thereof may be used in combination.

The solvent component of the liquid crystal aligning agent may include only a specific solvent or may be a solvent mixture containing a solvent other than the specific solvent and the specific solvent. Examples of the other solvent include a highly polar solvent such as N-methyl-2-pyrrolidone, N-ethyl-2-pyrrolidone, 1,2-dimethyl-2-imidazolidinone, γ-butyrolactone, γ-butyrolactam, N,N-dimethylformamide, and N,N-dimethylacetamide; and 4-hydroxy-4-methyl-2-pentanone, butyl lactate, butyl acetate, methyl methoxypropionate, ethyl ethoxypropionate, diethylene glycol dimethyl ether, diethylene glycol diethyl ether, diethylene glycol monomethyl ether, diethylene glycol monoethyl ether, diethylene glycol monomethyl ether acetate, diethylene glycol monoethyl ether acetate, isoamyl propionate, isoamyl isobutyrate, diisopentyl ether, ethylene carbonate, propylene carbonate, cyclohexane, octanol, and tetrahydrofuran. These can be used alone or two or more thereof can be used in a mixture.

Here, among the above other solvents, the highly polar solvent can be used in order to further improve solubility and leveling properties, and the hydrocarbon solvent having no amide structure can be used so that application to a plastic base material and low temperature firing are possible.

Regarding the solvent component contained in the liquid crystal aligning agent, a content proportion of the specific solvent is preferably 20 mass % or more, more preferably 40 mass % or more, most preferably 50 mass % or more, and particularly preferably 80 mass % or more with respect to a total amount of the solvent contained in the liquid crystal aligning agent. The liquid crystal aligning agent which is a blend of the polymer (A) and the polymer (B) is suitable because a liquid crystal element having excellent liquid crystal alignment properties and electrical characteristics is obtained even if the solvent component in the liquid crystal aligning agent includes only the specific solvent.

Regarding the polymer component, the liquid crystal aligning agent which is a blend of the polymer (A) and the polymer (B) is suitable because a liquid crystal element having excellent liquid crystal alignment properties and electrical characteristics is obtained even if it does not substantially contain N-methyl-2-pyrrolidone (NMP). Here, in this specification, “does not substantially contain NMP” means that a content proportion of NMP is preferably 5 mass % or less, more preferably 3 mass % or less, and most preferably 0.5 mass % or less with respect to a total amount of the solvent contained in the liquid crystal aligning agent.

A concentration of a solid content in the liquid crystal aligning agent (a ratio of a total mass of components other than the solvent of the liquid crystal aligning agent to a total mass of the liquid crystal aligning agent) is appropriately selected in consideration of viscosity, volatility, and the like, but it is preferably in a range of 1 to 10 mass %. When a concentration of a solid content is less than 1 mass %, a film thickness of a coating film becomes very small and it is difficult to obtain a favorable liquid crystal alignment film. On the other hand, when a concentration of a solid content exceeds 10 mass %, a film thickness of a coating film becomes very large and it is difficult to obtain a favorable liquid crystal alignment film, and the viscosity of the liquid crystal aligning agent tends to increase and coating properties tend to deteriorate.

### <<Liquid Crystal Alignment Film and Liquid Crystal Element>>

A liquid crystal alignment film of the present disclosure is formed using the liquid crystal aligning agent prepared as above. In addition, a liquid crystal element of the present disclosure includes the liquid crystal alignment film formed using the liquid crystal aligning agent described above. An operation mode of a liquid crystal in the liquid crystal element is not particularly limited, and various modes, for example, a TN type, an STN type, a VA type (including a VA-MVA type and a VA-PVA type), in-plane switching (IPS) type, a fringe field switching (FFS) type, an optically compensated bend (OCB) type, and a polymer sustained alignment (PSA) type) can be applied. The liquid crystal element can be produced by, for example, a method including the following process 1 to process 3. In the process 1, a substrate used varies according to a desired operation mode. Operation modes are the same in the process 2 and the process 3.

### <Process 1: Formation of Coating Film>

First, a liquid crystal aligning agent is applied to a substrate, and preferably, a coated surface is heated and thereby a coating film is formed on the substrate. As the substrate, for example, a transparent substrate made of glass such as float glass and soda glass; and a plastic such as polyethylene terephthalate, polybutylene terephthalate, polyether sulfone, polycarbonate, and poly(alicyclic olefin) can be used. As a transparent conductive film provided on one surface of a substrate, a NESA film made of tin oxide (SnO₂) (registered trademark commercially available from PPG, UAS), an ITO film made of indium oxide-tin oxide (In₂O₃—SnO₂), and the like can be used. In a case of a TN type, STN type or VA type liquid crystal element is produced, two substrates on which a patterned transparent conductive film is provided are used. On the other hand, in a case of an IPS type or FFS type liquid crystal element is produced, a substrate on which an electrode patterned in a comb-teeth shape is provided and a counter substrate on which no electrode is provided are used. Application of the liquid crystal aligning agent to the substrate is performed on an electrode formation surface by preferably an offset printing method, a flexographic printing method, a spin coating method, a roll coater method or an ink jet printing method.

After the liquid crystal aligning agent is applied, in order to prevent dripping of the applied liquid crystal aligning agent, preliminary heating (pre-baking) is preferably performed. A pre-baking temperature is preferably 30 to 200° C. and a pre-baking time is preferably 0.25 to 10 minutes. Then, the solvent is completely removed and, as necessary, a firing (post-baking) process is performed in order to thermally imidize an amic acid structure in the polymer. A firing temperature (post-baking temperature) in this case is preferably 80 to 250° C. and more preferably 80 to 200° C. A post-baking time is preferably 5 to 200 minutes. In particular, when the liquid crystal aligning agent is used, solubility with respect to a low boiling point solvent such as the specific solvent is favorable, and even if the post-baking temperature is, for example, 200° C. or lower, preferably 180° C. or lower, and more preferably 160° C. or lower, it is possible to obtain a liquid crystal element having excellent liquid crystal alignment properties and electrical characteristics. The film thickness of the film formed in this manner is preferably 0.001 to 1 μm.

### <Process 2: Alignment Treatment>

In a case of a TN type, STN type, IPS type or FFS type liquid crystal element is produced, a treatment (alignment treatment) in which a liquid crystal alignment ability is imparted to the coating film formed in the process 1 is performed. Therefore, the alignment ability of liquid crystal molecules is imparted to the coating film to form a liquid crystal alignment film. As the alignment treatment, a photoalignment treatment in which light is emitted to the coating film formed on the substrate and thereby a liquid crystal alignment ability is imparted to the coating film is preferable. On the other hand, in a case of a vertically aligned type liquid crystal element is produced, the coating film formed in the process 1 can be directly used as a liquid crystal alignment film. However, in order to further improve the liquid crystal alignment ability, an alignment treatment may be performed on the coating film.

Light emission for photoalignment can be performed by a method in which light is emitted to a coating film after the post-baking process, a method in which light is emitted to a coating film after the pre-baking process and before the post-baking process, a method in which light is emitted to a coating film while the coating film is heated in at least of the pre-baking process and the post-baking process, or the like. As light emitted to the coating film, for example, ultraviolet rays and visible light including light with a wavelength of 150 to 800 nm can be used. Ultraviolet rays including light with a wavelength of 200 to 400 nm are preferable. When emission light is polarized light, it may be linearly polarized light or partially polarized light. When emission light used is linearly polarized light or partially polarized light, light emission may be performed in a direction perpendicular to the surface of the substrate, an oblique direction, or a combination thereof. A light emission direction when non-polarized light is emitted is an oblique direction.

Examples of a light source used include a low pressure mercury lamp, a high pressure mercury lamp, a deuterium lamp, a metal halide lamp, an argon resonance lamp, a xenon lamp, and an excimer laser. A radiation amount of light emitted is preferably 400 to 50,000 J/m² and more preferably 1,000 to 20,000 J/m². After light emission for imparting an alignment ability, the surface of the substrate may be subjected to a process of washing using, for example, water, an organic solvent (for example, methanol, isopropyl alcohol, 1-methoxy-2-propanol acetate, butyl cellosolve, and ethyl lactate), or a mixture thereof and a process of heating the substrate.

### <Process 3: Construction of Liquid Crystal Cell>

Two substrates on which the liquid crystal alignment film is formed as described above are prepared and a liquid crystal is disposed between the two substrates disposed to face each other to produce a liquid crystal cell. When a liquid crystal cell is produced, for example, a method in which two substrates are disposed to face each other with a gap therebetween so that liquid crystal alignment films face each other, peripheral parts of the two substrates are bonded together using a sealing agent, a liquid crystal is injected and filled into a cell gap surrounded by the surface of the substrate and the sealing agent, and an injection hole is sealed, a method according to an ODF scheme, and the like may be used. As the sealing agent, for example, an epoxy resin containing a curing agent and aluminum oxide spheres as a spacer can be used. Examples of the liquid crystal include a nematic liquid crystal and a smectic liquid crystal. Among them, a nematic liquid crystal is preferable. In a PSA mode, after a liquid crystal cell is constructed, a process of emitting light to the liquid crystal cell is performed while a voltage is applied between conductive films having a pair of substrates.

Next, as necessary, a polarizing plate is bonded to the outer surface of the liquid crystal cell to form a liquid crystal element. Examples of the polarizing plate include a polarizing plate in which a polarizing film called an “H film” in which iodine is absorbed while an polyvinyl alcohol is stretched and aligned is interposed between cellulose acetate protective films and a polarizing plate formed of an H film itself.

The liquid crystal element of the present disclosure can be effectively applied for various applications, and can be applied for, for example, various display devices for a clock, a portable game, a word processor, a laptop computer, a car navigation system, a camcorder, a PDA, a digital camera, a mobile phone, a smartphone, various monitors, a liquid crystal television, and an information display, a light control film, and a retardation film.

### EXAMPLES

Examples will be described below in further detail. However, details of the present disclosure are not limited to the following examples.

In the following examples, a weight average molecular weight (Mw)) of a polymer, a number average molecular weight (Mn), and a molecular weight distribution (Mw/Mn) were measured by the following methods.

### <Weight Average Molecular Weight, Number Average Molecular Weight, and Molecular Weight Distribution>

According to gel permeation chromatography (GPC), Mw and Mn were measured under the following conditions. In addition, the molecular weight distribution (Mw/Mn) was calculated from the obtained Mw and Mn.

Device: “GPC-101” commercially available from Showa Denko K.K.
GPC column: Combination of “GPC-KF-801,” “GPC-KF-802,” “GPC-KF-803,” and “GPC-KF-804” commercially available from Shimadzu Glc Ltd.
Mobile phase: tetrahydrofuran (THF)
Column temperature: 40° C.
Flow rate: 1.0 mL/min
Sample concentration: 1.0 mass %
Sample injection volume: 100 μL
Detector: differential refractometer
Standard substance: monodisperse polystyrene

### <Imidization Ratio of Polymer>

A solution containing a polyimide was added to pure water, the obtained precipitate was sufficiently dried at room temperature under a reduced pressure, and then dissolved in deuterated dimethylsulfoxide, and ¹H-NMR was measured at room temperature using tetramethylsilane as a reference substance. An imidization ratio was obtained from the obtained ¹H-NMR spectrum using the following Equation (1).

Imidization ratio (%)=(1−(A¹/(A²×α)))×100 (1)

(in Equation (1), A¹ is a peak area derived from protons of an NH group appearing near a chemical shift of 10 ppm, A² is a peak area derived from other protons, and a is a ratio of the number of other protons to one proton of an NH group in a precursor (polyamic acid) of a polymer.)

Compounds used in the following examples are as follows. Here, in the following description, for convenience of description, a “compound represented by Formula (X)” may be simply referred to as “Compound (X).”

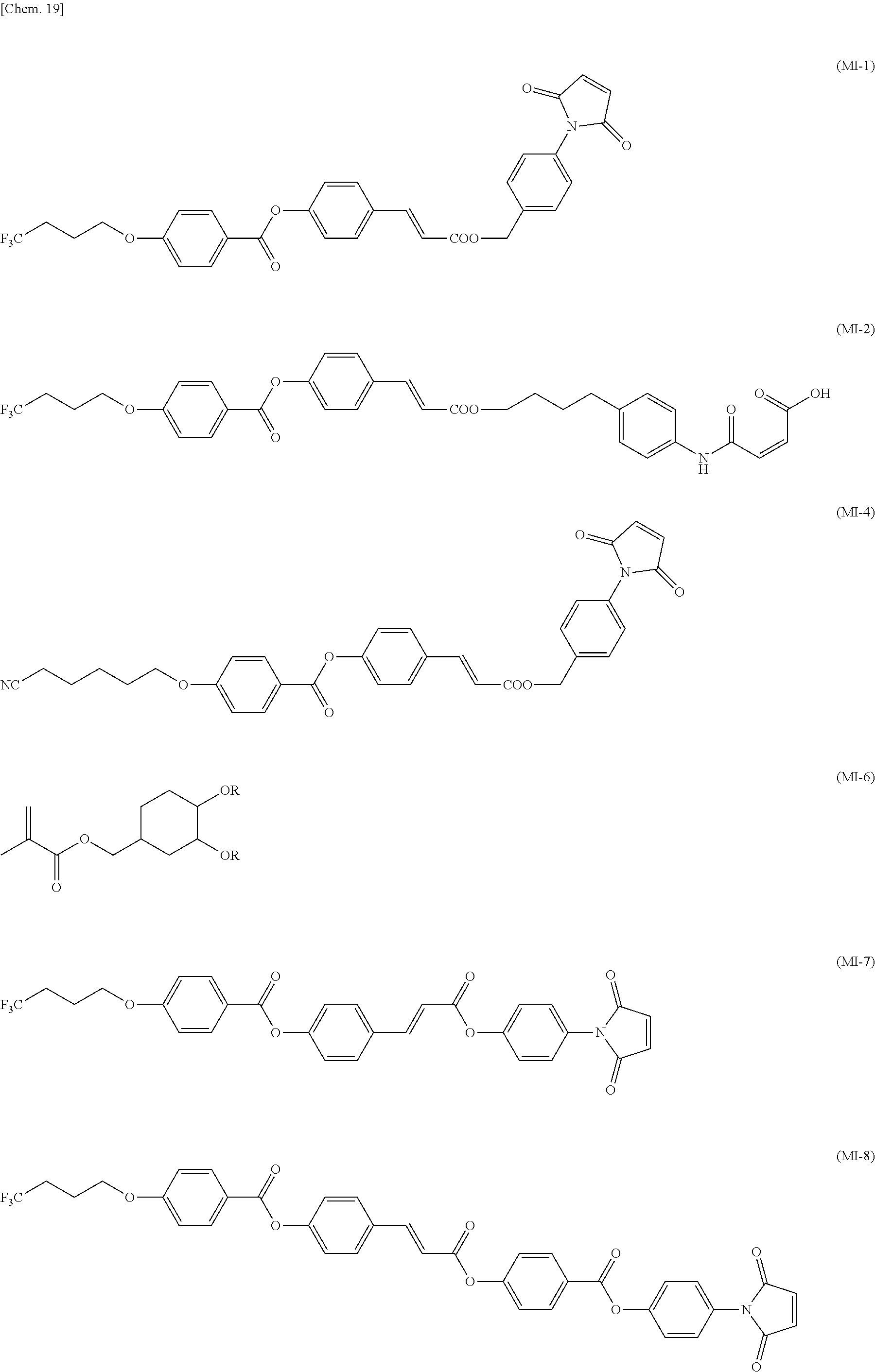

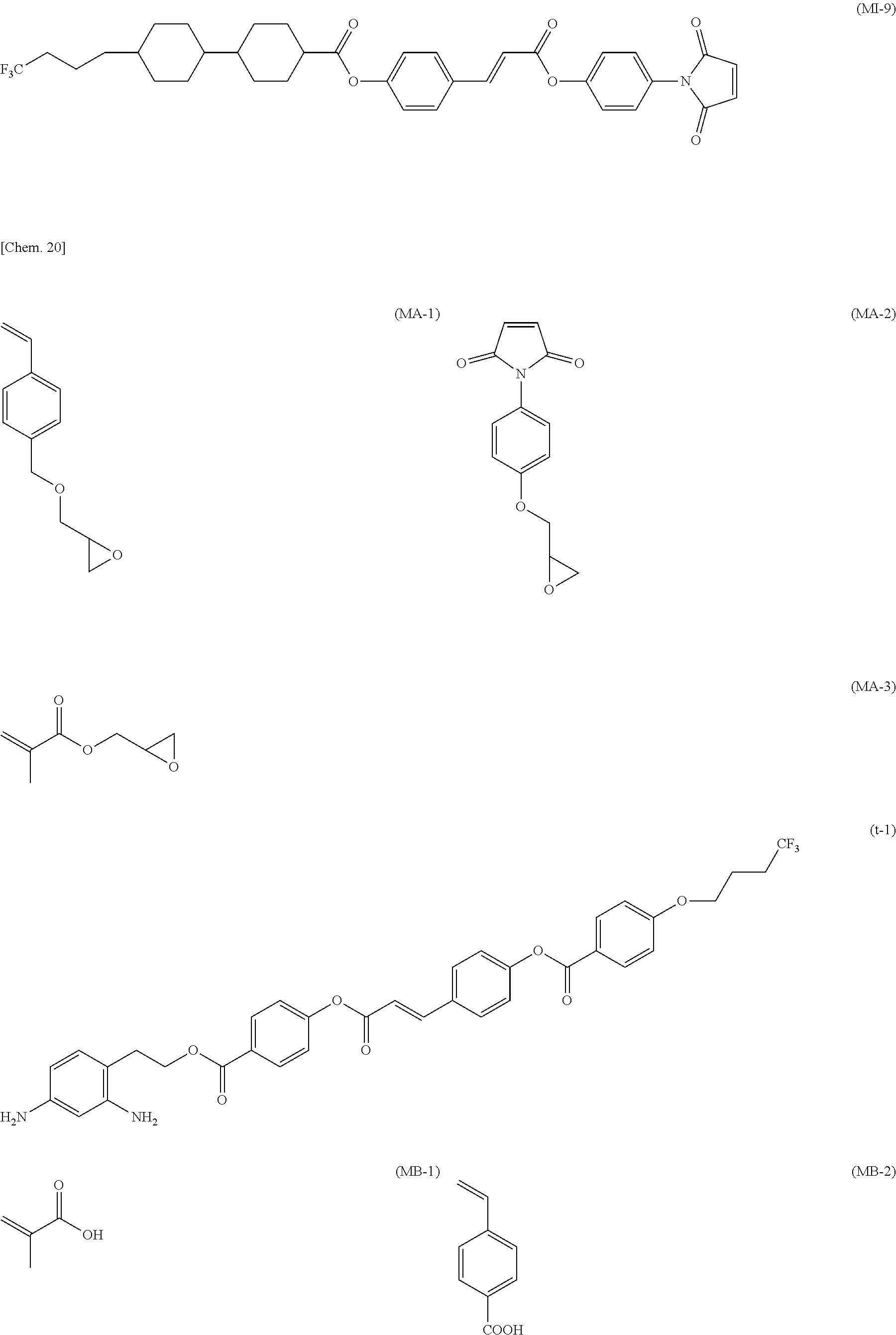

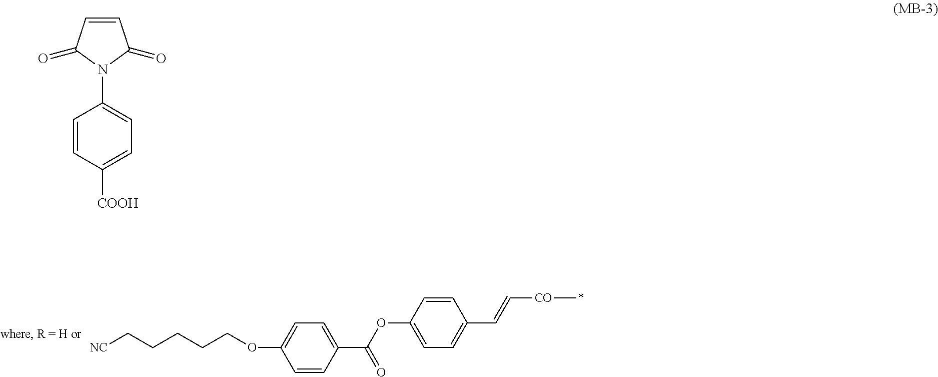 [SMILES: O=C(O)c1ccc(N2C(=O)C=CC2=O)cc1 ; *C(=O)/C=C/c1ccc(OC(=O)c2ccc(OCCCCCC#N)cc2)cc1]

### Synthesis of Monomer

### Synthesis Example 1-1

Compound (MI-1) was synthesized according to the following Scheme 1.

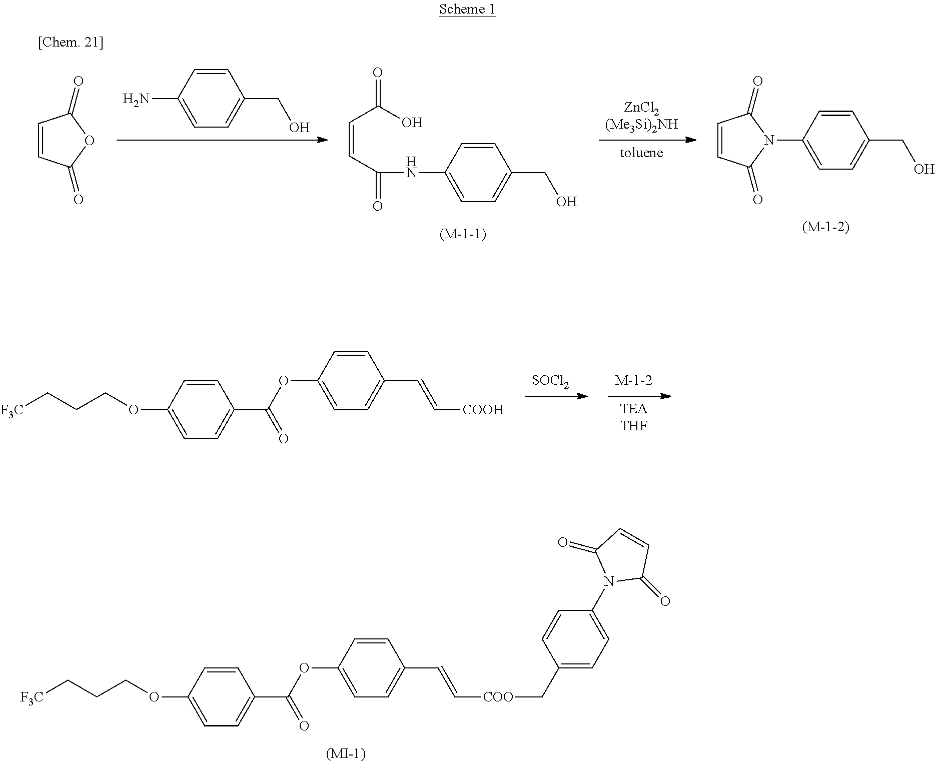

### Synthesis of Compound (M-1-1)

12.3 g of (4-aminophenyl)methanol was put into a 2,000 mL 3-necked flask having a stirrer therein, and 200 g of tetrahydrofuran was added thereto, and the flask was ice-bathed. A solution containing 9.81 g of succinic anhydride and 200 g of tetrahydrofuran was added dropwise thereto, and the mixture was stirred at room temperature for 3 hours. Then, the precipitated yellow solid was collected through filtration. The yellow solid was vacuum-dried to obtain 21.0 g of Compound (M-1-1).

### Synthesis of Compound (M-1-2)

17.7 g of Compound (M-1-1), 10.9 g of zinc chloride (II) and 250 g of toluene were put into a 500 mL 3-necked flask having a stirrer therein, and the mixture was heated and stirred at 80° C. A solution containing 23.2 g of bis(trimethylsilyl)amine and 100 g of toluene was added dropwise thereto and the mixture was stirred at 80° C. for 5 hours. Then, 300 g of ethyl acetate was added to the reaction solution, and washing with 1 mol/L hydrochloric acid was performed twice, washing with an aqueous sodium hydrogen carbonate solution was performed once, and washing with saturated saline was performed once. Then, an organic layer was slowly concentrated using a rotary evaporator so that a content amount became 50 g, and the precipitated white solid was collected through filtration during progress. The white solid was vacuum-dried to obtain 8.13 g of Compound (M-1-2).

### Synthesis of Compound (MI-1)

11.8 g of (E)-3-(4-((4-(4,4,4-trifluorobutoxy)benzoyl)oxy)phenyl)acrylic acid, 20 g of thionyl chloride, and 0.01 g of N,N-dimethylformamide were put into a 100 mL eggplant flask having a stirrer therein, and the mixture was stirred at 80° C. for 1 hour. Then, excess thionyl chloride was removed by a diaphragm pump, and 100 g of tetrahydrofuran was added to obtain a solution A.

Newly, 6.09 g of Compound (M-1-2), 200 g of tetrahydrofuran and 12.1 g of trimethylamine were put into a 500 mL3-necked flask having a stirrer therein, and the flask was ice-bathed. The solution A was added dropwise thereto, and the mixture was stirred at room temperature for 3 hours. The reaction solution was re-precipitated in 800 mL of water and the obtained white solid was vacuum-dried to obtain 13.7 g of Compound (MI-1).

### Synthesis Example 1-2

Compound (MI-2) was synthesized according to the following Scheme 2.

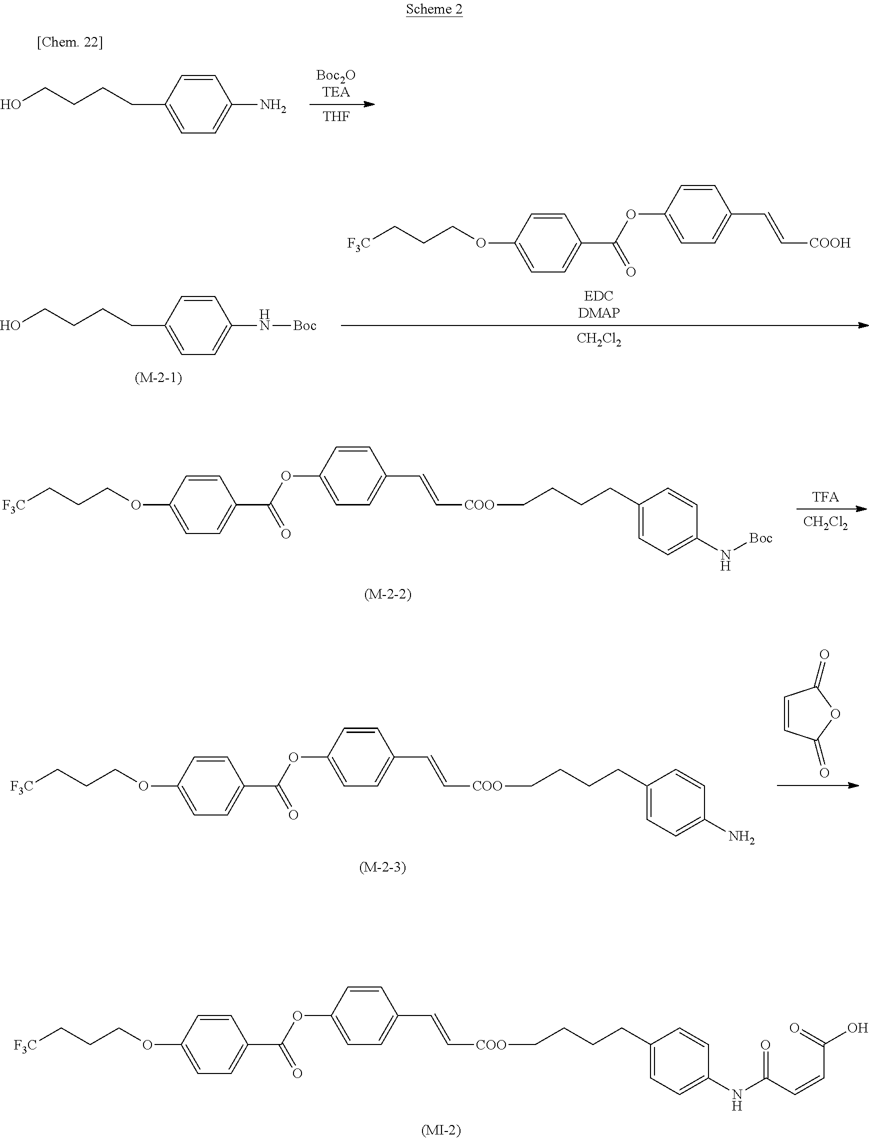

### Synthesis of Compound (M-2-1)

16.5 g of 4-(4-aminophenyl)butan-1-ol and 1,000 g of tetrahydrofuran were put into a 2,000 mL 3-necked flask having a stirrer therein, and 15.1 g of trimethylamine was added thereto, and the flask was ice-bathed. A solution containing 24.0 g of t-butyl Bicarbonate and 100 g of tetrahydrofuran was added dropwise thereto and the mixture was stirred at room temperature for 10 hours. Then, 300 g of ethyl acetate was added to the reaction solution, and washing with 200 g of distilled water was performed four times. Then, an organic layer was slowly concentrated using a rotary evaporator so that a content amount became 100 g, and the precipitated white solid was collected through filtration during progress. The white solid was vacuum-dried to obtain 25.2 g of Compound (M-2-1).

### Synthesis of Compound (M-2-2)

21.2 g of Compound (M-2-1) and 31.5 g of (E)-3-(4-((4-(4,4,4-trifluorobutoxy)benzoyl)oxy)phenyl)acrylic acid were put into a 2,000 mL 3-necked flask having a stirrer therein, and 1,000 g of dichloromethane was added thereto, and the flask was ice-bathed. 1.95 g of N,N-dimethylaminopyridine and 23.0 g of 1-ethyl-3-(3-dimethylaminopropyl)carbodiimide hydrochloride were added thereto in that order, and the mixture was stirred at room temperature for 8 hours, and washing with 500 g of distilled water was then performed four times. Then, an organic layer was slowly concentrated using a rotary evaporator so that a content amount became 100 g, and the precipitated white solid was collected through filtration during progress. The white solid was vacuum-dried to obtain 33.2 g of Compound (M-2-2).

### Synthesis of Compound (M-2-3)

27.3 g of Compound (M-2-2) and 28.5 g of trifluoroacetic acid were put into a 300 mL eggplant flask having a stirrer therein, and 50 g of dichloromethane was added thereto, and the mixture was stirred at room temperature for 1 hour. Then, the mixture was neutralized with a saturated aqueous sodium hydrogen carbonate solution and washing with 50 g of distilled water was then performed four times. Then, an organic layer was slowly concentrated using a rotary evaporator so that a content amount became 50 g, and the precipitated white solid was collected through filtration during progress. The white solid was vacuum-dried to obtain 26.5 g of Compound (M-2-3).

### Synthesis of Compound (MI-2)

Compound (MI-2) was obtained in the same synthesis manner as in Compound (M-1-1) using Compound (M-2-3) as a starting substance.

### Synthesis Example 1-3

### Synthesis of Compound (MI-4)

11.4 g of (E)-3-(4-((4-((5-cyanopentyl)oxy)benzoyl)oxy)phenyl)acrylic acid, 20 g of thionyl chloride, and 0.01 g of N,N-dimethylformamide were put into a 100 mL eggplant flask having a stirrer therein, and the mixture was stirred at 80° C. for 1 hour. Then, excess thionyl chloride was removed by a diaphragm pump, and 100 g of tetrahydrofuran was added to obtain a solution A.

Newly, 6.09 g of Compound (M-1-2), 200 g of tetrahydrofuran and 12.1 g of trimethylamine were put into a 500 mL 3-necked flask having a stirrer therein, and the flask was ice-bathed. The solution A was added dropwise thereto, and the mixture was stirred at room temperature for 3 hours. The reaction solution was re-precipitated in 800 mL of water and the obtained white solid was vacuum-dried to obtain 13.1 g of Compound (MI-4).

### Synthesis Example 1-4

Compound (MI-6) was synthesized according to the following Scheme 4.

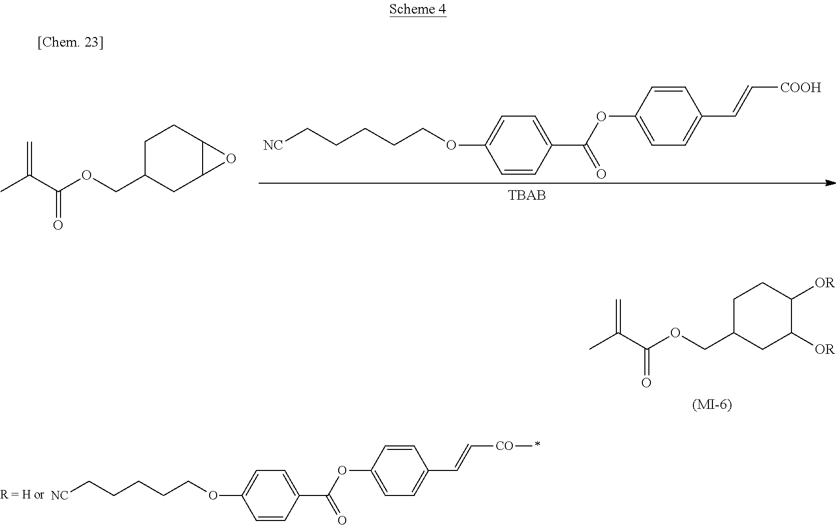

### Synthesis of Compound (MI-6)

9.81 g of methacrylic acid 7-oxabicyclo [4.1.0] heptan-3-ylmethyl, 19.0 g of (E)-3-(4-((4-cyanopentyl)oxy)benzoyl)oxy)phenyl)acrylic acid, and 500 g of N-methyl pyrrolidone were put into a 1,000 mL eggplant flask having a stirrer therein, and 1.61 g of tetrabutylammonium bromide was added thereto, and the mixture was stirred at 110° C. for 3 hours. Then, 300 g of cyclohexane and 400 g of cyclopentanone were added to the reaction solution, and washing with 400 g of distilled water was performed five times. Then, an organic layer was slowly concentrated using a rotary evaporator so that a content amount became 50 g, and the precipitated white solid was collected through filtration during progress. The white solid was vacuum-dried to obtain 23.0 g of Compound (MI-6).

### Synthesis Example 1-5

Compound (MA-2) was synthesized according to the following Scheme 5.

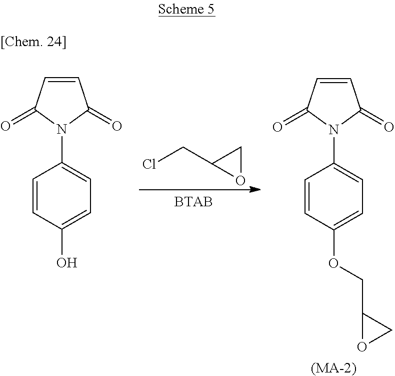

### Synthesis of Compound (MA-2)

100 g of epichlorohydrin and 18.7 g of p-hydroxyphenyl maleimide were put into a 500 mL 3-necked flask having a stirrer therein, and 1.8 g of benzyltrimethylammonium chloride was added thereto, and the mixture was stirred at 60° C. for 24 hours. Then, the reaction solution was dried under a reduced pressure, and the remaining solid was dissolved in 400 g of ethyl acetate. Washing with 400 g of distilled water was performed five times. Then, an organic layer was slowly concentrated using a rotary evaporator so that a content amount became a content amount became 20 g, and the precipitated solid was collected through filtration during progress. The solid was vacuum-dried to obtain 16.2 g of Compound (MA-2).

### Synthesis Example 1-6

Compound (MI-7) was synthesized according to the following Scheme 6.

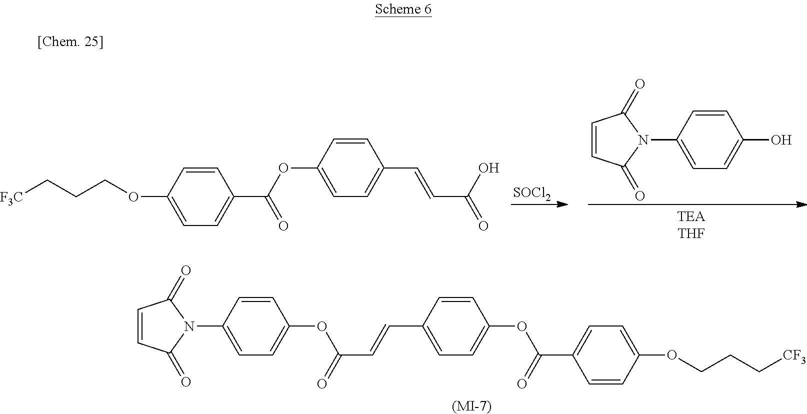

11.8 g of (E)-3-(4-((4-(4,4,4-trifluorobutoxy)benzoyl)oxy)phenyl)acrylic acid, 20 g of thionyl chloride, and 0.01 g of N,N-dimethylformamide were put into a 100 mL eggplant flask having a stirrer therein, and the mixture was stirred at 80° C. for 1 hour. Then, excess thionyl chloride was removed by a diaphragm pump, and 100 g of tetrahydrofuran was added to obtain a solution A.

Newly, 5.67 g of 4-hydroxyphenyl maleimide, 200 g of tetrahydrofuran and 12.1 g of trimethylamine were put into a 500 mL3-necked flask having a stirrer therein, and the flask was ice-bathed. The solution A was added dropwise thereto, and the mixture was stirred at room temperature for 3 hours. The reaction solution was re-precipitated in 800 mL of water and the obtained white solid was vacuum-dried to obtain 13.3 g of Compound (MI-7).

### Synthesis Example 1-7

### Synthesis of Compound (MI-8)

16.1 g of Compound (MI-8) was obtained in the same method as in Synthesis Example 1-6 except that (E)-4-((3-(4-((4-(4,4,4-trifluorobutoxy)benzoyl)oxy)phenyl) acryloyl)oxy)benzoic acid was used in place of (E)-3-(4-((4-(4,4,4-trifluorobutoxy) benzoyl)oxy)phenyl)acrylic acid in Synthesis Example 1-6.

### Synthesis Example 1-8

### Synthesis of Compound (MI-9)

15.1 g of Compound (MI-9) was obtained in the same method as in Synthesis Example 1-6 except that (E)-3-(4-((4′-(4,4,4-trifluorobutyl)-[1,1′-bi(cyclohexane)]-4-carbonyl)oxy)phenyl)acrylic acid was used in place of (E)-3-(4-((4-(4,4,4-trifluorobutoxy)benzoyl)oxy)phenyl)acrylic acid in Synthesis Example 1-6.

### Synthesis of Polymer

### Synthesis Example 2-1

Under a nitrogen atmosphere, 5.00 g (8.6 mmol) of Compound (MI-1) obtained in Synthesis Example 1-1, 0.64 g (4.3 mmol) of 4-vinylbenzoic acid, 2.82 g (13.0 mmol) of 4-(2,5-dioxo-3-pyrrolin-1-yl)benzoate and 3.29 g (17.2 mmol) of 4-(glycidyloxymethyl)styrene as a polymerization monomer, 0.31 g (1.3 mmol) of 2,2′-azobis(2,4-dimethylvaleronitrile) as a radical polymerization initiator, 0.52 g (2.2 mmol) of 2,4-diphenyl-4-methyl-1-pentene as a chain transfer agent and 25 m1 of tetrahydrofuran as a solvent were put into a 100 mL 2-necked flask, and the mixture was polymerized at 70° C. for 5 hours. The mixture was re-precipitated in n-hexane and the precipitate was then filtrated off, and vacuum drying was performed at room temperature for 8 hours to obtain a desired polymer (P-1). A weight average molecular weight Mw in terms of polystyrene standards measured through GPC was 30,000, and a molecular weight distribution Mw/Mn was 2.

### Synthesis Examples 2-2 to 2-13

Polymers (P-2) to (P-13) having the same weight average molecular weight and molecular weight distribution as in the polymer (P-1) were obtained according to the same polymerization as in Synthesis Example 2-1 except that polymerization monomers were set to have types and molar ratios shown in the following Table 1. Here, the total number of moles of polymerization monomers was 43.1 mmol as in Synthesis Example 2-1. The numerical values in Table 1 indicate amounts of monomers prepared [mol %] with respect to all monomers used for synthesizing polymers.

TABLE 1

| | | Epoxy-g | | | Reactive-functional- | | | Photoalignable- | | | | | | |
|---|---|---|---|---|---|---|---|---|---|---|---|---|---|---|
| | | roup-containing | | | group-containing | | | group-containing | | | | | | |
| | Name of | monomer | | | monomer | | | monomer | | | | | | |
| | polymer | MA-1 | MA-2 | MA-3 | MB-1 | MB-2 | MB-3 | MI-1 | MI-2 | MI-4 | MI-6 | MI-7 | MI-8 | MI-9 |
| Synthesis Example 2-1 | P-1 | 40 | — | — | — | 10 | 30 | 20 | — | — | — | — | — | — |
| Synthesis Example 2-2 | P-2 | 40 | — | — | — | 10 | 30 | — | — | 20 | — | — | — | — |
| Synthesis Example 2-3 | P-3 | — | — | 25 | 25 | — | — | — | — | — | 50 | — | — | — |
| Synthesis Example 2-4 | P-4 | 40 | — | — | — | 10 | 30 | — | 20 | — | — | — | — | — |
| Synthesis Example 2-5 | P-5 | 45 | — | — | — | | 45 | 10 | — | — | — | — | — | — |
| Synthesis Example 2-6 | P-6 | 35 | — | — | — | 10 | 25 | 30 | — | — | — | — | — | — |
| Synthesis Example 2-7 | P-7 | — | 40 | — | — | — | 40 | 20 | — | — | — | — | — | — |
| Synthesis Example 2-8 | P-8 | 40 | 40 | — | — | — | — | 20 | — | — | — | — | — | — |
| Synthesis Example 2-9 | P-9 | — | — | — | — | 40 | 40 | 20 | — | — | — | — | — | — |
| Synthesis Example | P-10 | — | — | 30 | 30 | 20 | — | 20 | — | — | — | — | — | — |
| 2-10 | | | | | | | | | | | | | | |
| Synthesis Example | P-11 | 40 | — | — | — | 10 | 30 | — | — | — | — | 20 | — | — |
| 2-11 | | | | | | | | | | | | | | |
| Synthesis Example | P-12 | 40 | — | — | — | 10 | 30 | — | — | — | — | — | 20 | — |
| 2-12 | | | | | | | | | | | | | | |
| Synthesis Example | P-13 | 40 | — | — | — | 10 | 30 | — | — | — | — | — | — | 20 |
| 2-13 | | | | | | | | | | | | | | |

### Synthesis Example 2-14

13.8 g (70.0 mmol) of 1,2,3,4-cyclobutanetetracarboxylic acid dianhydride as a tetracarboxylic acid dianhydride, and 16.3 g (76.9 mmol) of 2,2′-dimethyl-4,4′-diaminobiphenyl as a diamine were dissolved in 170 g of NMP, and reacted at 25° C. for 3 hours to obtain a solution containing 10 mass % of a polyamic acid. Next, the polyamic acid solution was poured into an excessively large amount of methanol, and the reaction product was precipitated. The precipitate was washed with methanol and dried at 40° C. for 15 hours under a reduced pressure to obtain a polyamic acid (PAA-1).

### Synthesis Examples 2-15 to 2-20

Polymers of polyamic acids (PAA-2) to (PAA-7) were obtained in the same synthesis manner as in Synthesis Example 2-14 except that polymerization monomers were set to have types and molar ratios shown in the following Table 2. The numerical values in Table 2 indicate amounts of monomers prepared [mol part] with respect to a total amount of tetracarboxylic acid dianhydride used for synthesizing polymers.

### Synthesis Example 2-21

13.8 g (70.0 mmol) of 1,2,3,4-cyclobutanetetracarboxylic acid dianhydride as tetracarboxylic acid dianhydride, and 49.9 g (76.9 mmol) of Compound (t-1) as a diamine were dissolved in 170 g of N-methyl-2-pyrrolidone (NMP), and reacted at 25° C. for 3 hours to obtain a solution containing 10 mass % of a polyamic acid. Next, the polyamic acid solution was poured into an excessively large amount of methanol, and the reaction product was precipitate. The precipitate was washed with methanol and dried at 40° C. for 15 hours under a reduced pressure to obtain a polymer (PAA-8) as a polyamic acid.

### Synthesis Example 2-22

A polyamic acid solution was obtained in the same synthesis manner as in Synthesis Example 2-14 except that polymerization monomers were set to have types and molar ratios shown in the following Table 2. Next, pyridine and acetic anhydride were added to the obtained polyamic acid solution and chemical imidization was performed. The reaction solution after chemical imidization was poured into an excessively large amount of methanol, and the reaction product was precipitated. The precipitate was washed with methanol and dried at 40° C. for 15 hours under a reduced pressure to obtain a polyimide (PI-1). An imidization ratio of the obtained polyimide (PI-1) was 20%.

TABLE 2

| | | Acid | | | | | |
|---|---|---|---|---|---|---|---|
| | | dianhydride | | Diamine 1 | | Diamine 2 | |
| | Name of | | Amount | | Amount | | Amount |
| | polymer | Type | added | Type | added | Type | added |
| Synthesis | PAA-1 | TC-1 | 100 | DA-1 | 100 | — | — |
| Example | | | | | | | |
| 2-14 | | | | | | | |
| Synthesis | PAA-2 | TC-2 | 100 | DA-2 | 100 | — | — |
| Example | | | | | | | |
| 2-15 | | | | | | | |
| Synthesis | PAA-3 | TC-2 | 100 | DA-2 | 70 | DA-3 | 30 |
| Example | | | | | | | |
| 2-16 | | | | | | | |
| Synthesis | PAA-4 | TC-2 | 100 | DA-2 | 70 | DA-4 | 30 |
| Example | | | | | | | |
| 2-17 | | | | | | | |
| Synthesis | PAA-5 | TC-1 | 100 | DA-2 | 100 | — | — |
| Example | | | | | | | |
| 2-18 | | | | | | | |
| Synthesis | PAA-6 | TC-1 | 100 | DA-2 | 70 | DA-4 | 30 |
| Example | | | | | | | |
| 2-19 | | | | | | | |
| Synthesis | PAA-7 | TC-3 | 100 | DA-2 | 100 | — | — |
| Example | | | | | | | |
| 2-20 | | | | | | | |
| Synthesis | PAA-8 | TC-1 | 100 | t-1 | 100 | — | — |
| Example | | | | | | | |
| 2-21 | | | | | | | |
| Synthesis | PI-1 | TC-2 | 100 | DA-2 | 70 | DA-3 | 30 |
| Example | | | | | | | |
| 2-22 | | | | | | | |

In Table 2, abbreviations of compounds are as follows.

### (Tetracarboxylic Acid Dianhydride)

TC-1: 1,2,3,4-cyclobutanetetracarboxylic acid dianhydride
TC-2: 2,3,5-tricarboxycyclopentyl acetic acid dianhydride
TC-3: pyromellitic dianhydride

### (Diamine)

DA-1: 2,2′-dimethyl-4,4′-diaminobiphenyl
DA-2: 1,3,3a,4,5,9b-hexahydro-8-methyl-5-(tetrahydro-2,5-dioxo-3-furanyl)naphtho [1,2-c] furan-1,3-dione
DA-3: 3,5-cholestanil diaminobenzoate
DA-4: 3,5-diaminobenzoic acid
t-1: compound represented by Formula (t-1)

### Production and Evaluation of Optically Vertical Type Liquid Crystal Display Element

### Example 1

### 1. Preparation of Liquid Crystal Aligning Agent (AL-1)

N-methyl-2-pyrrolidone (NMP) and butyl cellosolve (BC) as a solvent were added to 10 parts by mass of the polymer (P-1) obtained in Synthesis Example 2-1 as the polymer (A) and 100 parts by mass of the polyamic acid (PAA-1) obtained in Synthesis Example (2-14) as the polymer (B) to obtain a solution with a solvent composition of NMP/BC=50/50 (mass ratio) and a solid content concentration of 4.0 mass %. The solution was filtrated through a filter with a pore size of 1 μm to prepare a liquid crystal aligning agent (AL-1).

### 2. Evaluation of Transparency of Varnish

The liquid crystal aligning agent (AL-1) prepared above was visually observed. The transparency of the liquid crystal aligning agent was evaluated as “good (∘)” when there was no turbidity, and evaluated as “poor (x)” when there was turbidity. In the result of this example, the transparency was evaluated as “good (∘).”

### 3. Evaluation of Coating Properties

The liquid crystal aligning agent (AL-1) prepared above was applied to a glass substrate using a spinner and pre-baked on a hot plate at 50° C. for 2 minutes, and then heated (post-baked) in an oven of which the inside was purged with nitrogen at 200° C. for 30 minutes, and thereby a coating film with an average film thickness of 0.1 μm was formed. The coating film was observed under a microscope with a magnification of 100 and 10, and it was checked whether the film thickness was irregular and there were pinholes. Neither the irregular film thickness nor the occurrence of pinholes was observed even when observed with a microscope with a magnification of 100, it was evaluated as “good (A).” At least one of the irregular film thickness and the occurrence of pinholes was observed with a microscope with a magnification of 100, but neither the irregular film thickness nor the occurrence of pinholes was observed with a microscope with a magnification of 10, it was evaluated as “acceptable (B).” At least one of the irregular film thickness and the occurrence of pinholes was clearly observed with a microscope with a magnification of 10, it was evaluated as “poor (C).” In this example, neither the irregular film thickness nor the occurrence of pinholes was observed with a microscope with a magnification of 100, and coating properties were evaluated as “good (A).”

In order to evaluate coating properties in further detail, coating properties were evaluated at an edge part (the outer edge part of the formed coating film). The liquid crystal aligning agent (AL-1) prepared above was applied to a surface of a transparent electrode on a glass substrate to which the transparent electrode made of an ITO film was attached using a printer for coating a liquid crystal alignment film and dried in the same manner as above. The shape and the flatness of the edge part were observed. When the linearity was high and the surface was flat, it was evaluated as “good (A).” When the linearity was high but there were irregularities, it was evaluated as “acceptable (B).” When there were irregularities and there was liquid return from the edge (linearity was low), it was evaluated as “poor (C).” In the result of this example, the coating properties were determined as “good (A).”

### 4. Production of Optically Vertical Type Liquid Crystal Display Element

The liquid crystal aligning agent (AL-1) prepared above was applied to a surface of a transparent electrode on a glass substrate to which the transparent electrode made of an ITO film was attached using a spinner and pre-baked on a hot plate at 50° C. for 2 minutes. Then, heating was performed in an oven of which the inside was purged with nitrogen at 200° C. for 30 minutes to form a coating film with a film thickness of 0.1 μm. Next, polarized ultraviolet rays of 1,000 J/m² including a bright line of 313 nm were emitted to the surface of the coating film in a direction tilted at 40° from the normal line of the substrate using a Hg—Xe lamp and Gran-Taylor prism to impart a liquid crystal alignment ability. The same operations were repeated to prepare a pair of substrates (two substrates) having a liquid crystal alignment film.

An epoxy resin adhesive containing aluminum oxide spheres with a diameter of 3.5 μm was applied to the outer circumference of a surface having one liquid crystal alignment film between the substrates by screen printing. Then, liquid crystal alignment film surfaces of the pair of substrates were made to face each other and press-bonded so that directions of ultraviolet rays projected to the surfaces of the substrates along optical axes of the substrates were antiparallel, and the adhesive was thermally cured at 150° C. for 1 hour. Next, a negative type liquid crystal (MLC-6608 commercially available from Merch Group) was filled into gaps between the substrates through a liquid crystal inlet and the liquid crystal inlet was then sealed with an epoxy adhesive. In addition, in order to remove fluid flow alignment when a liquid crystal was injected, slow cooling was performed to room temperature while heating was performed at 130° C. Next, polarizing plates were bonded to both outer surfaces of the substrates so that polarization directions thereof were orthogonal to each other and formed an angle of 45° with respect to directions of ultraviolet rays projected to the surfaces of the substrates along optical axes in the liquid crystal alignment film, and thereby a liquid crystal display element was produced.

### 5. Evaluation of Liquid Crystal Alignment Properties

It was observed whether there was an abnormal domain in the change in the brightness under an optical microscope when a voltage of 5 V was turned ON and OFF (applied and released) for the liquid crystal display element produced above. The liquid crystal alignment properties were evaluated as “good (A)” when there was no abnormal domain, evaluated as “acceptable (B)” when there was an abnormal domain partially, and evaluated as “poor (C)” when there was an abnormal domain generally. In the result of this example, the liquid crystal alignment properties were “good (A).”

### 6. Evaluation of Voltage Holding Ratio (VHR)

A voltage of 5 V with an application time of 60 microseconds and a span of 167 milliseconds was applied to the liquid crystal display element produced above and a voltage holding ratio 167 milliseconds after application release was then measured. VHR-1 (commercially available from Toyo Corporation) was used as a measurement device. In this case, when the voltage holding ratio was 95% or more, it was evaluated as “very good (A),” when the voltage holding ratio was 80% or more and less than 95%, it was evaluated as “good (B),” when the voltage holding ratio was 50% or more and less than 80%, it was evaluated as “acceptable (C),” and when the voltage holding ratio was less than 50%, it was evaluated as “poor (D).” In the result of this example, the voltage holding ratio was evaluated as “very good (A).”

### Examples 2 to 10, and 12 to 23, and Comparative Examples 1, 2, and 4

Liquid crystal aligning agents were prepared with the same solid content concentration as in Example 1 except that the mixing composition was changed as shown in the following Table 3. In addition, transparency of the liquid crystal aligning agents were evaluated and coating properties were evaluated using the liquid crystal aligning agents in the same manner as in Example 1, and optically vertical type liquid crystal display elements were produced in the same manner as in Example 1 and various evaluations were performed. The results are shown in the following Table 4. Here, in the following Table 4, the result of observation of the irregular film thickness and pinholes is shown in the column “coating properties” and the result of observation of the edge part is shown in the column “edge coating properties.”

### Production and Evaluation of Optically Horizontal Type Liquid Crystal Display Element

### Example 11

### 1. Preparation of Liquid Crystal Aligning Agent (AL-11)

Propylene glycol monomethyl ether (PGME) and butyl cellosolve (BC) as a solvent were added to 10 parts by mass of the polymer (P-2) obtained in Synthesis Example 2-2 as the polymer (A) and 100 parts by mass of the polyamic acid (PAA-2) obtained in Synthesis Example (2-15) as the polymer (B) to obtain a solution with a solvent composition of PGME/BC=50/50 (mass ratio) and a solid content concentration of 4.0 mass %. The solution was filtered through a filter with a pore size of 1 μm to prepare a liquid crystal aligning agent (AL-11).

### 2. Evaluation of Transparency of Varnish

Transparency of the liquid crystal aligning agent was evaluated in the same manner as in Example 1 except that (AL-11) was used in place of (AL-1) as the liquid crystal aligning agent. In the result of this example, the transparency was evaluated as “good (∘).”

### 3. Evaluation of Coating Properties

Coating properties were evaluated in the same manner as in Example 1 except that (AL-11) was used in place of (AL-1) as the liquid crystal aligning agent. In the result of this example, neither the irregular film thickness nor the occurrence of pinholes was observed with a microscope with a magnification of 100, and the coating properties were evaluated as “good (A).” In addition, the coating properties of the edge part were determined as “good (A)” because the linearity was high and the surface was flat.

### 4. Production of Optically Horizontal Type Liquid Crystal Display Element

The liquid crystal aligning agent (AL-11) prepared above was applied to a surface of a transparent electrode on a glass substrate to which the transparent electrode made of an ITO film was attached using a spinner and pre-baked on a hot plate at 50° C. for 2 minutes. Then, heating was performed in an oven of which the inside was purged with nitrogen at 200° C. for 30 minutes to form a coating film with a film thickness of 0.1 jam. Next, polarized ultraviolet rays of 1,000 J/m² including a bright line of 313 nm were emitted to the surface of the coating film in a direction tilted at 90° from the normal line of the substrate using a Hg—Xe lamp and Gran-Taylor prism, and after polarized ultraviolet rays were emitted, a heating treatment on a hot plate at 150° C. was performed for 10 minutes. Such a series of operations were repeated to prepare a pair of substrates (two substrates) having a liquid crystal alignment film.

An epoxy resin adhesive containing aluminum oxide spheres with a diameter of 3.5 μm was applied to the outer circumference of a surface having one liquid crystal alignment film among the substrates by screen printing. Then, liquid crystal alignment film surfaces of the pair of substrates were made to face each other and press-bonded so that directions of ultraviolet rays projected to the surfaces of the substrates along optical axes of the substrates were horizontal, and the adhesive was thermally cured at 150° C. for 1 hour. Next, a positive type liquid crystal (MLC-7028-100 commercially available from Merch Group) was filled into gaps between the substrates through a liquid crystal inlet and the liquid crystal inlet was then sealed with an epoxy adhesive. In addition, in order to remove fluid flow alignment when a liquid crystal was injected, slow cooling was performed to room temperature while heating was performed at 130° C. Next, polarizing plates were bonded to both outer surfaces of the substrates so that polarization directions thereof were orthogonal to each other and formed an angle of 90° with respect to directions of ultraviolet rays projected to the surfaces of the substrates along optical axes in the liquid crystal alignment film, and thereby a liquid crystal display element was produced.

### 5. Evaluation of Liquid Crystal Alignment Properties

The liquid crystal alignment properties of the optically horizontal type liquid crystal display element produced above were evaluated in the same manner as in Example 1. In the result of this example, the liquid crystal alignment properties were “acceptable (B).”

### 6. Evaluation of Voltage Holding Ratio (VHR)

The voltage holding ratio of the optically horizontal type liquid crystal display element produced above was evaluated in the same manner as in Example 1. In the result of this example, the voltage holding ratio was evaluated as “very good (A).”

### Comparative Example 3

A liquid crystal aligning agent (BL-3) was prepared with the same solid content concentration as in Example 11 except that the mixing composition was changed as shown in the following Table 3. In addition, using the liquid crystal aligning agent (BL-3), transparency of the liquid crystal aligning agent was evaluated and coating properties were evaluated in the same manner as in Example 1, and an optically horizontal type liquid crystal display element was produced in the same manner as in Example 11, and various evaluations were performed. The results are shown in the following Table 4.

TABLE 3

| | Liquid | Polymer | | Polymer | | Other | | | | | | | |
|---|---|---|---|---|---|---|---|---|---|---|---|---|---|
| | crystal | (A) | | (B) | | polymer | | | | | | | |
| | aligning | | Parts by | | Parts by | | Parts by | Solvent 1 | | Solvent 2 | | Solvent 3 | |
| | agent | Type | mass | Type | mass | Type | mass | Type | Proportion | Type | Proportion | Type | Proportion |
| Example 1 | AL-1 | P-1 | 10 | PAA-1 | 100 | — | — | NMP | 50 | BC | 50 | — | — |
| Example 2 | AL-2 | P-1 | 10 | PAA-2 | 100 | — | — | NMP | 50 | BC | 50 | — | — |
| Example 3 | AL-3 | P-1 | 10 | PAA-2 | 100 | — | — | PGME | 50 | BC | 50 | — | — |
| Example 4 | AL-4 | P-1 | 10 | PAA-2 | 100 | — | — | CPN | 50 | BC | 50 | — | — |
| Example 5 | AL-5 | P-1 | 10 | PAA-3 | 100 | — | — | MB | 50 | BC | 50 | — | — |
| Example 6 | AL-6 | P-1 | 10 | PAA-3 | 100 | — | — | PCS | 50 | BC | 50 | — | — |
| Example 7 | AL-7 | P-1 | 10 | PAA-4 | 100 | — | — | PGME | 50 | BC | 50 | — | — |
| Example 8 | AL-8 | P-1 | 10 | PAA-4 | 100 | — | — | EDM | 20 | BC | 80 | — | — |
| Example 9 | AL-9 | P-1 | 10 | PAA-5 | 100 | — | — | PGME | 50 | BC | 50 | — | — |
| Example 10 | AL-10 | P-1 | 10 | PAA-6 | 100 | — | — | PGME | 50 | BC | 50 | — | — |
| Example 11 | AL-11 | P-2 | 10 | PAA-2 | 100 | — | — | PGME | 50 | BC | 50 | — | — |
| Example 12 | AL-12 | P-1 | 10 | PI-1 | 100 | — | — | PGME | 50 | BC | 50 | — | — |
| Example 13 | AL-13 | P-4 | 10 | PAA-2 | 100 | — | — | NMP | 50 | BC | 50 | — | — |
| Example 14 | AL-14 | P-1 | 10 | PAA-7 | 100 | — | — | PGME | 50 | BC | 50 | — | — |
| Example 15 | AL-15 | P-5 | 10 | PAA-4 | 100 | — | — | PGME | 50 | BC | 50 | — | — |
| Example 16 | AL-16 | P-6 | 10 | PAA-4 | 100 | — | — | PGME | 50 | BC | 50 | — | — |
| Example 17 | AL-17 | P-8 | 10 | PAA-4 | 100 | — | — | PGME | 50 | BC | 50 | — | — |
| Example 18 | AL-18 | P-9 | 10 | PAA-4 | 100 | — | — | PGME | 50 | BC | 50 | — | — |
| Example 19 | AL-19 | P-1 | 20 | PAA-4 | 100 | — | — | PGME | 50 | BC | 50 | — | — |
| Example 20 | AL-20 | P-10 | 10 | PAA-4 | 100 | — | — | PGME | 50 | BC | 50 | — | — |
| Example 21 | AL-21 | P-11 | 10 | PAA-2 | 100 | — | — | PGME | 50 | BC | 50 | — | — |
| Example 22 | AL-22 | P-12 | 10 | PAA-2 | 100 | — | — | PGME | 50 | BC | 50 | — | — |
| Example 23 | AL-23 | P-13 | 10 | PAA-2 | 100 | — | — | PGME | 50 | BC | 50 | — | — |
| Comparative | BL-1 | — | — | PAA-2 | 100 | — | — | PGME | 50 | BC | 50 | — | — |
| Example 1 | | | | PAA-8 | 10 | | — | | | | | | |
| Comparative | BL-2 | P-1 | 100 | — | — | — | — | PGME | 50 | BC | 50 | — | — |
| Example 2 | | | | | | | | | | | | | |
| Comparative | BL-3 | — | — | PAA-2 | 100 | P-3 | 10 | NMP | 25 | THF | 25 | BC | 50 |
| Example 3 | | | | | | | | | | | | | |
| Comparative | BL-4 | — | — | PAA-4 | 100 | P-7 | 10 | PGME | 50 | BC | 50 | — | — |
| Example 4 | | | | | | | | | | | | | |

In Table 3, the numerical values in the column of polymers indicate a proportion (parts by mass) of polymers added with respect to 100 parts by mass of the polymer (B) used for preparing the liquid crystal aligning agent in Examples 1 to 23 and Comparative Examples 3 and 4. In Comparative Example 1, the numerical value indicates a proportion (parts by mass) of the polymer (PAA-8) added with respect to 100 parts by mass of the polymer (PAA-2) used for preparing the liquid crystal aligning agent. In Comparative Example 2, only the polymer (A) was used as the polymer component.

Abbreviations of the solvents in Table 3 have the following meanings.

PGME: propylene glycol monomethyl ether
EDM: diethylene glycol methyl ethyl ether
CPN: cyclopentanone
MB: 3-methoxy-1-butanol
PCS: ethylene glycol monopropyl ether
NMP: N-methyl-2-pyrrolidone
BC: butyl cellosolve
THF: tetrahydrofuran

TABLE 4

| | | Transparency | Coating | Edge coating | Liquid crystal | |
|---|---|---|---|---|---|---|
| | Evaluation process | of varnish | properties | properties | alignment properties | VHR |
| Example 1 | Optically vertical type | ◯ | A | A | A | A |
| Example 2 | Optically vertical type | ◯ | A | A | B | A |
| Example 3 | Optically vertical type | ◯ | A | B | B | A |
| Example 4 | Optically vertical type | ◯ | A | B | B | A |
| Example 5 | Optically vertical type | ◯ | A | A | A | A |
| Example 6 | Optically vertical type | ◯ | A | A | A | A |
| Example 7 | Optically vertical type | ◯ | A | A | A | A |
| Example 8 | Optically vertical type | ◯ | A | A | A | A |
| Example 9 | Optically vertical type | ◯ | A | B | B | A |
| Example 10 | Optically vertical type | ◯ | A | A | A | A |
| Example 11 | Optically horizontal type | ◯ | A | A | B | A |
| Example 12 | Optically vertical type | ◯ | A | A | A | A |
| Example 13 | Optically vertical type | ◯ | A | A | A | A |
| Example 14 | Optically vertical type | ◯ | B | B | B | A |
| Example 15 | Optically vertical type | ◯ | A | A | A | A |
| Example 16 | Optically vertical type | ◯ | A | A | A | A |
| Example 17 | Optically vertical type | ◯ | A | B | A | B |
| Example 18 | Optically vertical type | ◯ | A | A | A | B |
| Example 19 | Optically vertical type | ◯ | A | A | A | A |
| Example 20 | Optically vertical type | ◯ | A | A | A | B |
| Example 21 | Optically vertical type | ◯ | A | A | A | A |
| Example 22 | Optically vertical type | ◯ | A | A | A | A |
| Example 23 | Optically vertical type | ◯ | A | A | A | A |
| Comparative | Optically vertical type | X | C | C | C | C |
| Example 1 | | | | | | |
| Comparative | Optically vertical type | ◯ | B | C | B | B |
| Example 2 | | | | | | |
| Comparative | Optically horizontal type | ◯ | B | C | A | A |
| Example 3 | | | | | | |
| Comparative | Optically vertical type | ◯ | A | C | A | B |
| Example 4 | | | | | | |

As can be understood from the above results of the examples, in Examples 1 to 23 using the liquid crystal aligning agent as a blend of the polymer (A) and the polymer (B), the transparency of the liquid crystal aligning agent was evaluated as “∘” in all of the examples. In addition, the liquid crystal alignment properties and the voltage holding ratio of the liquid crystal display elements were evaluated as “A” or “B” in all of the examples, and favorable results are shown. In particular, it can be understood that, in Examples 3 to 13, and 15 to 23 in which PGME, CPN, MB, PCS, EDM, and BC as a low boiling point solvent were used as solvent components, the liquid crystal alignment properties and the voltage holding ratio were evaluated as “A” or “B,” and excellent liquid crystal display characteristics were exhibited even if a low boiling point solvent was used.

On the other hand, in Comparative Example 1 in which only a polyamic acid was used as a polymer component, when a low boiling point solvent was used, the liquid crystal aligning agent became white turbid, and coating properties (including edge coating properties), liquid crystal alignment properties, and the voltage holding ratio were all evaluated as “C.” In addition, in Comparative Example 2 in which only the polymer (A) was used as a polymer component, coating irregularity was large, edge coating properties were poor, and the voltage holding ratio was low compared to Example 3 having the same solvent composition. In addition, Comparative Example 3 including a methacrylic polymer and a polyamic acid as a polymer component and Comparative Example 4 including a maleimide polymer and a polyamic acid had inferior edge coating properties to the example.

Based on the above results, it can be understood that it was possible to form a liquid crystal alignment film in which coating properties, liquid crystal alignment properties, and a voltage holding ratio are excellent according to the liquid crystal aligning agent as a blend of the polymer (A) and the polymer (B).

1. A liquid crystal aligning agent, comprising:
a polymer (A): a polymer having at least one structural unit U1 selected from a group consisting of a structural unit represented by Formula (1) and a structural unit represented by Formula (2), and a structural unit U2 derived from at least one monomer selected from a group consisting of styrene monomers and (meth)acrylic monomers; and
a polymer (B): at least one polymer selected from a group consisting of a polyamic acid, a polyamic acid ester and a polyimide, 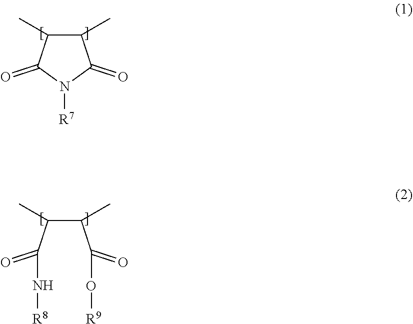
in Formula (1), R⁷ is a monovalent organic group having 1 or more carbon atoms; and in Formula (2), R⁸ is a monovalent organic group having 1 or more carbon atoms, and R⁹ is a hydrogen atom or a monovalent organic group having 1 or more carbon atoms.

2. The liquid crystal aligning agent according to claim 1, wherein the polymer (A) has at least one of an oxetanyl group and an oxiranyl group.

3. The liquid crystal aligning agent according to claim 2, wherein the polymer (A) further has a functional group that reacts with at least one of the oxetanyl group and the oxiranyl group by heating.

4. The liquid crystal aligning agent according to claim 1, wherein the polymer (A) has a photoalignable group.

5. The liquid crystal aligning agent according to claim 1, further comprising:
a solvent which is at least one selected from the group consisting of a compound represented by Formula (D-1), a compound represented by Formula (D-2), and a compound represented by Formula (D-3), and has a boiling point at 1 atmosphere of 180° C. or lower, 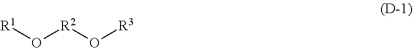
in Formula (D-1), R¹ is an alkyl group having 1 to 4 carbon atoms or CH₃CO—; R² is an alkanediyl group having 1 to 4 carbon atoms or —(CH₂CH₂O)n-CH₂CH₂—, wherein n is an integer of 1 to 4, and R³ is a hydrogen atom or an alkyl group having 1 to 4 carbon atoms; 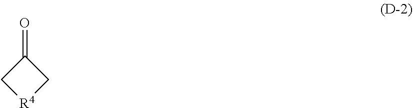
in Formula (D-2), R⁴ is an alkanediyl group having 1 to 3 carbon atoms; 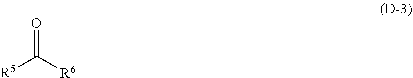
in Formula (D-3), R⁵ and R⁶ are independently an alkyl group having 4 to 8 carbon atoms.

6. The liquid crystal aligning agent according to claim 1, wherein the polymer (B) has a structural unit derived from an alicyclic tetracarboxylic acid derivative.

7. The liquid crystal aligning agent according to claim 1, wherein the polymer (B) has a structural unit derived from a diamine compound having a carboxyl group.

8. A liquid crystal alignment film formed using the liquid crystal aligning agent according claim 1.

9. A liquid crystal element comprising the liquid crystal alignment film according to claim 8.

10. The liquid crystal aligning agent according to claim 2, wherein the polymer (A) has a photoalignable group.

11. The liquid crystal aligning agent according to claim 3, wherein the polymer (A) has a photoalignable group.

12. The liquid crystal aligning agent according to claim 2, further comprising:
a solvent which is at least one selected from the group consisting of a compound represented by Formula (D-1), a compound represented by Formula (D-2), and a compound represented by Formula (D-3), and has a boiling point at 1 atmosphere of 180° C. or lower, 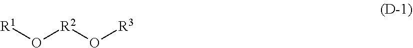
in Formula (D-1), R¹ is an alkyl group having 1 to 4 carbon atoms or CH₃CO—; R² is an alkanediyl group having 1 to 4 carbon atoms or —(CH₂CH₂O)n-CH₂CH₂—, wherein n is an integer of 1 to 4, and R³ is a hydrogen atom or an alkyl group having 1 to 4 carbon atoms; 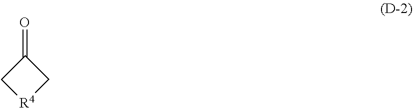
in Formula (D-2), R⁴ is an alkanediyl group having 1 to 3 carbon atoms; 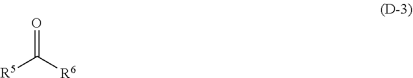
in Formula (D-3), R⁵ and R⁶ are independently an alkyl group having 4 to 8 carbon atoms.

13. The liquid crystal aligning agent according to claim 3, further comprising:
a solvent which is at least one selected from the group consisting of a compound represented by Formula (D-1), a compound represented by Formula (D-2), and a compound represented by Formula (D-3), and has a boiling point at 1 atmosphere of 180° C. or lower, 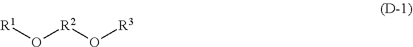
in Formula (D-1), R¹ is an alkyl group having 1 to 4 carbon atoms or CH₃CO—; R² is an alkanediyl group having 1 to 4 carbon atoms or —(CH₂CH₂O)n-CH₂CH₂—, wherein n is an integer of 1 to 4, and R³ is a hydrogen atom or an alkyl group having 1 to 4 carbon atoms; 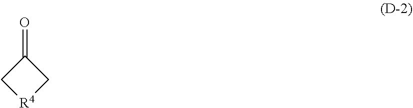
in Formula (D-2), R⁴ is an alkanediyl group having 1 to 3 carbon atoms; 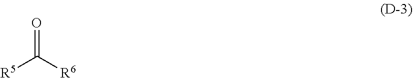
in Formula (D-3), R⁵ and R⁶ are independently an alkyl group having 4 to 8 carbon atoms.

14. The liquid crystal aligning agent according to claim 4, further comprising:
a solvent which is at least one selected from the group consisting of a compound represented by Formula (D-1), a compound represented by Formula (D-2), and a compound represented by Formula (D-3), and has a boiling point at 1 atmosphere of 180° C. or lower, 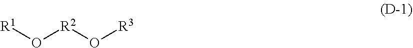
in Formula (D-1), R¹ is an alkyl group having 1 to 4 carbon atoms or CH₃CO—; R² is an alkanediyl group having 1 to 4 carbon atoms or —(CH₂CH₂O)n-CH₂CH₂—, wherein n is an integer of 1 to 4, and R³ is a hydrogen atom or an alkyl group having 1 to 4 carbon atoms; 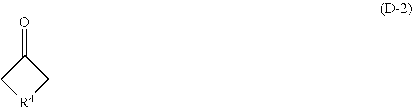
in Formula (D-2), R⁴ is an alkanediyl group having 1 to 3 carbon atoms; 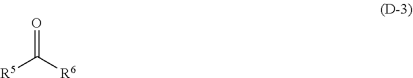
in Formula (D-3), R⁵ and R⁶ are independently an alkyl group having 4 to 8 carbon atoms.

15. The liquid crystal aligning agent according to claim 2, wherein the polymer (B) has a structural unit derived from an alicyclic tetracarboxylic acid derivative.

16. The liquid crystal aligning agent according to claim 3, wherein the polymer (B) has a structural unit derived from an alicyclic tetracarboxylic acid derivative.

17. The liquid crystal aligning agent according to claim 4, wherein the polymer (B) has a structural unit derived from an alicyclic tetracarboxylic acid derivative.

18. The liquid crystal aligning agent according to claim 2, wherein the polymer (B) has a structural unit derived from a diamine compound having a carboxyl group.

19. The liquid crystal aligning agent according to claim 3, wherein the polymer (B) has a structural unit derived from a diamine compound having a carboxyl group.

20. The liquid crystal aligning agent according to claim 4, wherein the polymer (B) has a structural unit derived from a diamine compound having a carboxyl group.
